(19) United States
(12) Patent Application Publication
(10) Pub. No.: US 2026/0058904 A1
(43) Pub. Date: Feb. 26, 2026

(54) SYSTEMS AND METHODS FOR SEGMENT ROUTING (SR)-BASED DATA FORWARDING AND DATA PROCESSING

(71) Applicant: Huawei Technologies Co., Ltd., Shenzhen (CN)

(72) Inventors: Chenchen Yang, Ottawa (CA); Xu Li, Nepean (CA); Weisen Shi, Ottawa (CA)

(21) Appl. No.: 19/360,793

(22) Filed: Oct. 16, 2025

Related U.S. Application Data
(63) Continuation of application No. PCT/CN2023/089317, filed on Apr. 19, 2023.

(51) Int. Cl. H04L 45/42; H04L 45/243

(52) U.S. Cl. CPC H04L 45/42; H04L 45/243

(57) ABSTRACT

The disclosure provides for systems and methods for SR-based data forwarding and data processing. According to an aspect a method is provided. The method includes generating a plurality of module block information (MBI) and one or more fork indications (FIs). Each MBI corresponds to a module of a plurality of modules involved in a mission. Each FI indicates a forked module of the plurality of modules, where each forked module splits a data path into multiple forked paths. The method may further include arranging the plurality of MBIs and the one or more FIs into an ordered list based on an order of involvement of the plurality of modules in the mission. The method may further include sending to one or more service controllers, the ordered list.

### CROSS-REFERENCE TO RELATED APPLICATION

This application is a continuation of International Application No. PCT/CN2023/089317, filed on Apr. 19, 2023, the disclosure of which is hereby incorporated by reference in its entirety.

### TECHNICAL FIELD

The present disclosure pertains to the field of communication networks, and in particular to systems and methods for SR-based data forwarding and data processing.

### BACKGROUND

Future networks may operate based in part on mission management concept. Under this concept, data may be forwarded to execute a mission, which may involve multiple data paths (including forked paths) and data aggregation points. However, existing technologies for data forwarding prevent formation of loop transmission, which may be needed in future networks to perform, for example, data processing. Further, existing technologies, for example, technologies which rely on multicast distribution tree (MDT), may require frequent configuration and updates at each involving node, leading to weak performance. In addition to said limitations, existing technologies may have limited or weak scalability in terms of data processing configuration, which may further render such technologies in inadequate for future networks.

Therefore, there is a need for systems and methods for SR-based data forwarding and data processing that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure provides for systems and methods for SR-based data forwarding and data processing. According to an aspect a method may be provided for programming handling information for data forwarding and data processing. The method may be performed by a control plane function, e.g., a mission management function or a mission manager (MM). The method includes generating, by a control plane function, a plurality of module block information (MBI) and one or more fork indications (FIs). Each MBI may correspond to a module of a plurality of modules involved in a mission. The one or more FIs may indicate one or more forked modules of the plurality of modules, where each forked module of the one or more forked modules splits a data path into multiple forked paths. The method may further include arranging, by the control plane function, the plurality of MBIs and the one or more FIs into an ordered list based on an order of involvement of the plurality of modules in the mission. The method may further include sending, by the control plane function to one or more service controllers, the ordered list.

Arranging, by the control plane function, the plurality of MBIs and the one or more FIs into an ordered list based on an order of mission involvement of the plurality of modules may include setting, by the control plane function, at a first position in the ordered list, a first MBI of the plurality of MBIs corresponding to a first module of the plurality of modules, the first module being a firstly involved module based on the order of involvement.

The method may further include setting, by the control plane function, in the ordered list and after the first MBI, one or more MBIs corresponding to one or more modules involved in the mission after the first module up to and including a first forked module, the one or more MBIs arranged according to the order of involvement of the corresponding one or more modules and the first forked module in the mission, the first forked module splitting the data path into a plurality of forked paths of the first forked module.

The first module may be a first forked module, and the first MBI may be an MBI of the first forked module.

The method may further include setting a plurality of sets of handling data in the ordered list after the MBI of the first forked module. Each set of handling data may correspond to a respective forked path of the plurality of forked paths of the first forked module. Each set of handling data may comprise one or more of MBIs corresponding to one or more modules in the respective forked path. Each set of handling data may further comprise an FI corresponding to a first module in the respective forked path and being involved in the mission after the first forked module.

The plurality of the plurality of forked paths of the first forked module may execute the mission in parallel.

Setting a plurality of sets of handling data in the ordered list after the after the MBI of the first forked module may include, for each forked path of the plurality of forked paths of the first forked module, setting the respective FI and the respective one or more MBIs in the ordered list based on the order of involvement in the mission of the corresponding one or more modules in the respective forked path.

The method may further include setting in the ordered list after the MBI of the first forked module and before the plurality of sets of handling data, an FI corresponding to the first forked module.

At least one of the plurality of forked paths of the first forked modules may include one or more forked modules. For each of the at least one of the plurality of forked paths, each forked module of the one or more forked modules may split a respective data path into a respective plurality of forked paths of said each forked module. For each of the at least one of the plurality of forked paths, the one or more forked modules and the first forked module may be involved in the mission according to the order of involvement. For each of the at least one of the plurality of forked paths, the method may further include, for each respective forked module of the one or more forked modules, setting in the ordered list and after an MBI of a forked module previous to said each forked module, as determined according to the order of involvement, a first handling data. The first handling data may include one or more MBIs corresponding to one or more modules involved in the mission after the forked module previous to said each forked module, and up to and including said each forked module. The first handling data may further comprise an FI corresponding to a first modules being involved in the mission after the forked module previous to said each forked module.

For each of the at least one of the plurality of forked paths, the method may further include, for each respective forked module of the one or more forked modules, setting, by the control plane function, in the ordered list and after the first handling data, a plurality of sets of handling data. Each set of handling data may correspond to a respective forked path of the respective plurality of forked paths of said each forked module. Each set of handling data may include one or more of MBIs corresponding to one or more modules involved in the respective forked path. Each set of handling data may further include an FI corresponding to a first module in the respective forked path and being involved in the mission after said each forked module.

For each of at least one of the plurality of sets of handling data, the respective one or more MBIs may correspond to one or more modules involved in the respective forked path, and up to and including a forked module of the one or more forked modules subsequent to said each forked module, as determined according to the order of involvement.

The respective plurality of forked paths of each forked module of the plurality of forked module may execute the mission in parallel.

The one or more MBIs and the FI in the first handling data may be arranged according to the order of involvement in the mission of their corresponding one or more modules. The one or more MBIs and the FI in said each set of handling data may be arranged according to the order of involvement in the mission of their corresponding one or more modules.

For each forked module of the one or more forked modules of the at least one of the plurality of forked paths of the first forked module, the method may further include setting, in the ordered list, after the MBI of the forked module previous to said each forked module and before the first handling data, an FI corresponding to the forked module previous to said each forked module.

For each forked module of the one or more forked modules of the at least one of the plurality of forked paths of the first forked module, the method may further include setting, in the ordered list, after the first handling data and before the plurality of sets of handling data, an FI corresponding to said each forked module.

The method may further include setting an FI value to an FI corresponding to the first forked module. The method may further include, for each FI corresponding to said each forked module, setting a respective FI value based on an FI value corresponding to the FI of the forked module previous to said each forked module.

Each MBI of the plurality of MBIs may include one or more of: a path selection information (PSI), a function indication, metrics, and a data aggregation indication (DAI). The PSI may indicate one or more of: a path identifier (ID) identifying a traffic path from a processing function (PF) corresponding to said each MBI to a next-hop PF of the PF; a connection ID identifying a connection between the PF and the next-hop PF; an ID of the next-hop PF; an ID of a radio bearer; and an ID of the PF.

The function indication may be one or more IDs of one or more functions according to which one or more PFs involved in the mission process data. The one or more functions may include: a data processing type, a data processing algorithm, the mission, a submission of the mission, and a task of the mission.

The metrics indicate a requirement on data processing for a module corresponding to said each MBI, the metrics including one or more of: a quality of service (QoS) requirement on one or both of data processing and data forwarding, a parameter for security protection, a parameter for integrity protection, a parameter for authentication, an input data format, and an output data format.

According to another aspect, another method is provided. The method may be performed by a PF entity involved in a mission. The method includes receiving, by the PF entity, an ordered list of a plurality of module block information (MBIs) and one or more fork indications (FIs). Each MBI may correspond to a module of a plurality of modules involved in the mission. The one or more FIs may indicate one or more forked modules of the plurality of modules. The plurality of MBIs and FIs may be arranged in the ordered list based on an order of involvement of the plurality of modules in the mission. The method may further include encapsulating, by the PF entity, a packet header of a packet with updated handling data based on the ordered list. The method may further include sending, by the PF entity, to a next-hop PF entity the encapsulated packet. The encapsulated packet may be sent based on a path selection information (PSI) of an MBI of the PF entity, the MBI of the PF entity being included in the ordered list.

The PF entity may receive the ordered list from a service controller. The updated handling data may include the ordered list of MBIs and the one or more FIs and excludes the MBI of the PF entity.

The PF entity may be at a forked module and the next-hop PF entity may be on a first forked path of a plurality of forked paths beginning from the PF entity. The updated handling data may include one or more MBIs of the plurality of MBIs corresponding to one or more modules of the plurality of modules involved in the first forked path. The one or more MBIs may be arranged according to an order of mission involvement of the one or more modules in the first forked path. The encapsulated packet may be a unicast packet.

The updated handling data may further include one or more FIs of one or more forked modules involved in the first forked path. The one or more MBIs and the one or more FIs may be arranged according to an order of mission involvement of the one or more modules and the one or more forked modules in the first forked path.

The PF entity may be at a forked module and sending, by the PF entity to a next-hop PF entity, the encapsulated packet may include sending, by the PF entity to each of a plurality of next-hop PF entities, the encapsulated packet as a multicast packet. Each of the plurality of next-hop PF entities may be on a respective forked path of a plurality of forked paths beginning from the PF entity.

For each of the plurality of next-hop PF entities that an identifier (ID) of said each next-hop PF entity is indicated in an MBI of the said each next-hop PF entity included in the ordered list, the updated handling data may include one or more of: MBIs and FIs of a set of modules of the plurality of modules involved in the plurality of forked paths.

For each of the plurality of next-hop PF entities that an identifier (ID) of said each next-hop PF entity is indicated in the MBI of the PF entity, the updated handling data may include one or more of MBIs and FIs: of the PF entity and a set of modules of the plurality of modules involved in the plurality of forked paths.

The method may further include processing, by the PF entity, data based on a data processing configuration to obtain a processed result, wherein the processed result is included in a payload of the encapsulated packet.

The data processing configuration may be indicated via one of: a message received by the PF entity from a control plane function indicating one or more functions according to which the PF entity processes the data, and the MBI of the PF entity.

The PF entity may be at a user equipment, and the encapsulated packet is sent via a radio bearer identified by the PSI of the MBI of the PF entity, the MBI of the PF entity being included in the ordered list.

The method may further include receiving, by the PF entity from another PF entity at a user equipment, the data associated with the mission.

The PF entity receives the ordered list in the packet header of the packet from another PF entity. The method may further include receiving, by the PF entity from the another PF entity, the data associated with the mission in the packet.

One of the PF entity and the next-hop PF entity may be a core network (PF) entity and the other, a radio access network (RAN) PF. The PF entity may be a core network (CN) PF entity, and the next-hop PF entity may be a radio access network (RAN) PF.

The next-hop PF entity may be at a user equipment (UE), and the encapsulated packet may be sent via a radio bearer identified by a path selection information (PSI) of the MBI of the PF entity. The MBI of the PF entity may be included in the ordered list. The PF entity may be a radio access network (RAN) PF entity.

Each MBI of the plurality of MBIs may include one or more of: a respective path selection information (PSI), a function indication, metrics, and a data aggregation indication (DAI). The respective PSI may indicate one or more of: a path identifier (ID) identifying a traffic path from a processing function (PF) of said each MBI to a next-hop PF; a connection ID identifying a connection between the PF of said MBI and the next-hop PF; an ID of the next-hop PF; an ID of a radio bearer; and an ID of the PF of said each MBI.

The function indication may be one or more IDs of one or more functions according to which one or more PFs involved in the mission process data. The one or more functions may include: a data processing type, a data processing algorithm, the mission, a submission of the mission, and a task of the mission.

The metrics may indicate a requirement on data processing for a module corresponding to said each MBI. The metrics may include one or more of: a quality of service (QoS) requirement on one or both of data processing and data forwarding, a parameter for security protection, a parameter for integrity protection, a parameter for authentication, an input data format, and an output data format.

According to another aspect, an apparatus is provided. The apparatus includes modules configured to perform one or more of the methods and systems described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1A illustrates a mission comprising several tasks.

FIG. 1B illustrates the mission of FIG. 1A in terms of processing functions (PFs).

FIG. 2 illustrates segment routing multiprotocol label switching (SR-MPLS) based on adjacency segment identifiers (SIDs).

FIG. 3 illustrates a packet format of segment routing IPV6 (SRv6).

FIG. 4 illustrates information included in a segment list of an SRV6 packet.

FIG. 5 illustrates an SRv6 spray for multicast transmission.

FIG. 6 illustrates Tree-SID in SRv6 and Multiprotocol Label Switching (MPLS).

FIG. 7 illustrates an applicable XaaS system architecture, according to an aspect.

FIG. 8 illustrates a connection between two border processing functions, according to an aspect.

FIG. 9 illustrates PFs involved in multiple missions, according to an aspect.

FIG. 10 illustrates a mission comprising multiple paths with forks and an aggregation point, according to an aspect.

FIG. 11A illustrates a packet header, according to an aspect.

FIG. 11B is another illustration of packet header of FIG. 11A, according to an aspect.

FIG. 12 illustrates a traffic of a mission without forks, according to an aspect.

FIG. 13 illustrates a packet header of a straight data path, according to an aspect.

FIG. 14 illustrates a procedure for programming data routing and processing information, according to an aspect.

FIG. 15A illustrates programming of MBI and FI of a first forked module, according to an aspect.

FIG. 15B illustrates further programming of MBI and FI after the programming of FIG. 15A, according to an aspect.

FIG. 15C illustrates further programming of MBI and FI after the programming in FIG. 15B, according to an aspect.

FIG. 15D illustrates further programming of MBI and FI, after the programming in FIG. 15C, according to an aspect.

FIG. 16 illustrates a first method for packet header decapsulation, according to an aspect.

FIG. 17 illustrates a second method for packet header decapsulation, according to an aspect.

FIG. 18 illustrates a source node sending data to receivers, according to an aspect.

FIG. 19 illustrates MBIs and FIs included a packet header corresponding to path segments of FIG. 10, according to an aspect.

FIG. 20 illustrates the packet headers received, via method of FIG. 16, by M[k] and M[j] of FIG. 10, according to an aspect.

FIG. 21 illustrates the packet headers received, via method of FIG. 16, by M[m] and M[a] of FIG. 10, according to an aspect.

FIG. 22 illustrates the packet headers received, via method of FIG. 16, by M[a] and M[p] of FIG. 10, according to an aspect.

FIG. 23 illustrates the packet header received, via method of FIG. 17, by M[k] and M[j] of FIG. 10, according to an aspect.

FIG. 24 illustrates the packet headers received, via method of FIG. 17, by M[m] and M[a] of FIG. 10, according to an aspect.

FIG. 25 illustrates the packet headers received, via method of FIG. 17, by M[a] and M[p] of FIG. 10, according to an aspect.

FIGS. 26A and 26B illustrate a procedure for SR-based configuration and mission execution, according to an aspect.

FIG. 27 illustrates a path information (path table), according to an aspect.

FIG. 28 illustrates a method for programming handling information for data forwarding and data processing, according to an aspect.

FIG. 29 illustrates another method, according to an aspect.

FIG. 30 illustrates an apparatus that may perform any or all of operations of the above methods and features explicitly or implicitly described herein, according to different aspects of the present disclosure.

It will be noted that throughout the appended drawings, like features are identified by like reference numerals.

### DETAILED DESCRIPTION OF THE ILLUSTRATIVE EMBODIMENTS

The disclosure provides systems and methods for data forwarding and data processing. According to an aspect of the present disclosure, a method may be provided for programming handling information for data forwarding and data processing.

The method may be performed by a control plane function, e.g., a MM (mission manager). The method includes generating a plurality of module block information (MBI) and one or more fork indications (FIs). Each MBI may correspond to a module of a plurality of modules involved in a mission. The one or more FIs may indicate one or more forked modules of the plurality of modules, where each forked module of the one or more forked modules splits a data path into multiple forked paths. The method may further include arranging, by the control plane function, the plurality of MBIs and the one or more FIs into an ordered list based on an order of involvement of the plurality of modules in the mission. The method may further include sending, by the control plane function to one or more service controllers, the ordered list.

According to another aspect, another method is provided. The method may be performed by a PF entity involved in a mission. The method includes receiving, by the PF entity, an ordered list of a plurality of module block information (MBIs) and one or more fork indications (FIs). Each MBI may correspond to a module of a plurality of modules involved in the mission. The one or more FIs may indicate one or more forked modules of the plurality of modules. The plurality of MBIs and FIs may be arranged in the ordered list based on an order of involvement of the plurality of modules in the mission. The method may further include encapsulating, by the PF entity, a packet header of a packet with updated handling data based on the ordered list. The method may further include sending, by the PF entity, to a next-hop PF entity the encapsulated packet. The encapsulated packet may be sent based on a path selection information (PSI) of an MBI of the PF entity, the MBI of the PF entity being included in the ordered list.

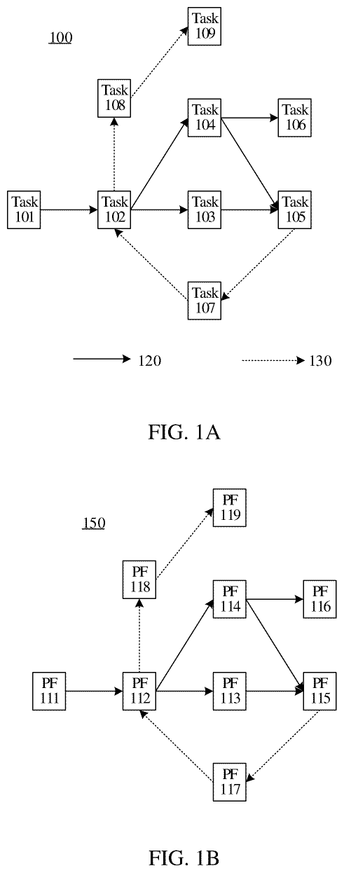

In sixth generation (6G) wireless communication system, X as a service (XaaS) network is proposed. The network works based on mission management concept. FIG. 1A illustrates a mission comprising several tasks. As illustrated, mission 100 may include several tasks (e.g., Tasks 101 to 109), and each task may be provided by a 6G service, e.g., data analytics and management (DAM) service, network for artificial intelligence (NET4AI) service, etc.

The tasks of mission 100 may be executed in specific order, and each task can be executed by a data processing function (PF) on the data plane as illustrated in FIG. 1B. FIG. 1B illustrates the mission of FIG. 1A in terms of PFs. The mission 150 corresponds to the mission 100 in terms of data PF or PF. Thus, tasks 101 may be executed or performed by data PF (or PF) 111, task 102 may be performed by PF 112, and similarly for each of remaining tasks, a corresponding PF may execute the task.

Data may be delivered to the PFs and the PFs may perform one or more data processing functions, e.g., data cleaning, AI training, AI inference, data analytics, data privacy protection, data storage, etc. Both data forwarding and data processing may be needed on data plane to execute a mission in 6G networks. In some aspects, the PF may be the evolved user plane function (UPF).

As mentioned, mission 100 may be executed in a specific order, for example, mission 100 may first be performed (e.g., data forwarded and tasks executed) according to the solid line arrows 120, and second, according to the dotted line arrows 130. Thus, mission 100 may be performed according to a data forwarding sequence. Mission 100 may first forward data according to a first data path based on the solid line arrows 120, and second, forward data according to a second data path based on the dotted line arrows 130.

The characteristics of traffic topology of the mission 100 may be described as follows. The traffic path of the mission may be a directed graph. The traffic path may include path forks e.g., packets from PF 112 is transmitted to both PF 113 and PF 114. That is, multicast transmission may be needed. In some aspects, the path may have transmission loop(s) and is not loop-free, which is different from data forwarding in traditional networks. In traditional network, data forwarding is done to avoid transmission loops. However, in future 6G service, transmission loops may exist to perform data processing. For example, data forwarded from PF 112 to PF 113 and further to PF 115 (based on data path associated with the solid line arrows) may then be forward back to PF 112 from PF 117 and PF 115 (based on a data path associated with the dotted line arrows). At the same time, PF 115 may receive data from both path segments PF 112-PF 114-PF 115 and PF112-PF113-PF115. The traffic path may have aggregation points, e.g., at PF 115.

Source routing is a scheme for data forwarding. In source routing, a source chooses a path and encodes it in a packet header as an ordered list of segments, and the rest of the network executes the encoded instructions. Segment routing (SR) is a technology that uses source routing to forward packets through the network. SR divides a network path into several segments and assigns a segment ID (SID) to each segment. The segments are sequentially arranged into a segment list to form a forwarding path. A packet is forwarded from segment to segment based on information carried in the packet.

Because more information may be added and carried in the packet, less state needs to be maintained in the network and the context to be maintained in network for data forwarding can potentially be simplified.

Segment routing may be divided into two types based on the forwarding plane. Segment Routing Multiprotocol Label Switching (MPLS) (SR-MPLS for short) is based on the MPLS forwarding plane, whereas Segment Routing Ipv6 (SRv6 for short) is based on the Ipv6 forwarding plane.

In SR-MPLS, an ordered list of segments is represented as a stack of labels. In SRv6, an ordered list of segments is encoded in a routing extension header.

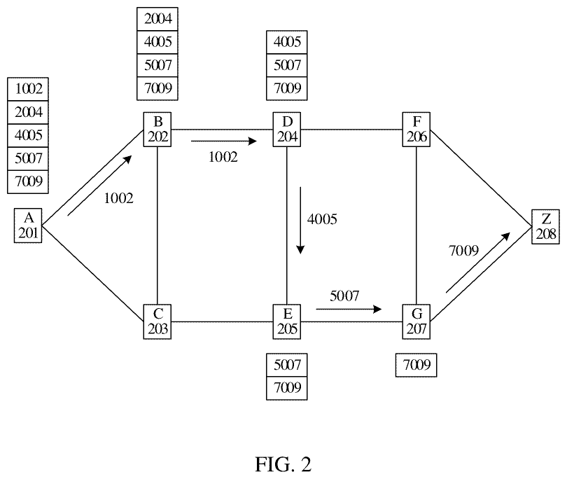

In SR-MPLS, the segment ID can be defined via three types: node SID, adjacency SID, prefix SID. As an example, adjacency SID can be described in reference to FIG. 2. FIG. 2 illustrates segment routing multiprotocol label switching (SR-MPLS) based on adjacency SIDs. Referring to FIG. 2, node A 201 may need to send a packet to node Z 208. To route the packet, an adjacency segment (identified by a SID) may be assigned to each adjacency between two nodes. The source node A 201 may then choose a path (e.g., A 201-B 202-D 204-E 205-G 207-Z 208) and encapsulate the ordered segment list in the packet header. The ordered segment list corresponding to the path may be (1002, 2004, 4005, 5007, 7009). The segment list may include multiple adjacency segment and indicate a strict path from source node A 201 to receiver node Z 208.

Beginning from node A 201, each node on the path may forward the packet to the next-hop node based on the SIDs (the ordered segment list) until the packet reaches node Z 208. Each node may remove the corresponding SID before sending the packet to next-hop node. For example, after receiving the packet from node A 201, node B 202 pops out SID 2004 from the SID list and forward the packet to node D 204, as illustrated.

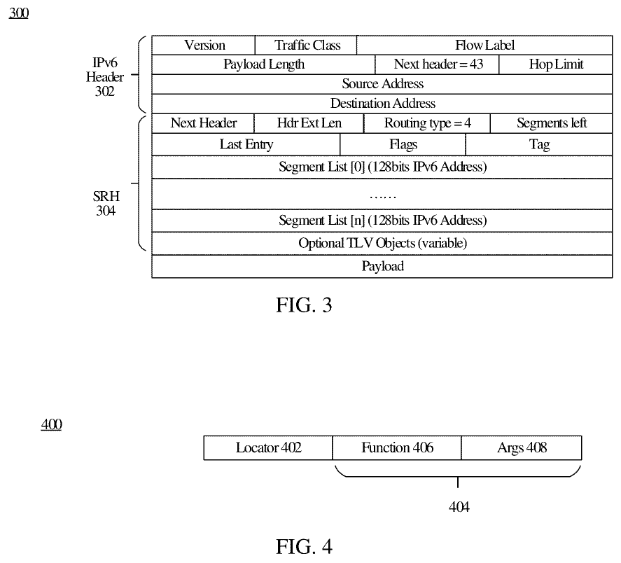

SRv6 is an implementation of SR (Segment Routing) in Ipv6. FIG. 3 illustrates a packet format of SRv6. The packet format 300 includes an Ipv6 header 302, an SR header (SRH) 304 and a payload. The SRH 304 is derived from the Ipv6 route header with a new Routing Type 4. The SRv6 can bring centralized control and programmability to the label-based switching.

The Ipv6 header 302 includes a plurality of fields indicating: version, traffic class, flow label, payload length, next header=43, hop limit, source address and destination address as illustrated. The destination address (DA) field indicates the Ipv6 packet's destination address, in the traditional Ipv6 packet. The DA is immutable and identifies the final destination, but in SRv6, the DA identifies only the next-hop node of the current packet and changes continuously.

The SRH 304 includes a plurality of fields indicating: next header, header extension length (hdr ext len), routing type=4, segments left, last entry, flags, tag, segment list [o] (128 bits Ipv6 Address) . . . segment list [n] (128 bits Ipv6 Address), and optional type-length-value (TLV) objects (variable). More information on SRH could be referred to standard document Requests for Comments (RFC) 8754.

As illustrated, the segment list (e.g., segment list [0] (128 bits Ipv6 Address) . . . segment list [n] (128 bits Ipv6 Address)) is carried in the SRH 304. An SRv6 segment is an Ipv6 address, which may also be called an SRv6 SID. The SRv6 may require the SIDs to be encapsulated inversely. The first parsed SID is located in the innermost of the SRH. Similar to the segment list of SR-MPLS, the segment list in SRv6 is encapsulated into the packet header by the source node.

FIG. 4 illustrates information included in a segment list of an SRV6 packet. The segment list may indicate a list of SRv6 SIDs. An SRv6 SID 400 includes a locator part 402 and a function part 404. The locator part 402 is for routing and identifies an address for the next-hop node. The function part 404 can identify any function of a device, for example, a forwarding behavior or a service behavior. The function part 404 can further include both a function field 406 and an optional parameter arguments field 408. The arguments field 408 can be used to define information such as flows and services of packets. Both function 406 and arguments 408 can be defined, which indicates that the SRv6 SID structure facilitates network programming. Therefore, one segment stands for one endpoint and one specific action. The segment list can express the behaviours in each transmission path, including the route and the actions in specific nodes. An SRv6 SID can be considered as a kind of network instruction. SRv6 differs from SR-MPLS in that SRv6 SIDs are not popped out after being processed by a node.

The segments left (SL) field in the SRH 304 indicates the number of route segments (i.e., SIDs) remaining for the packet to reach the final destination. Thus, SL field indicates the number of intermediate nodes that still need to be accessed before reaching the final destination. The SL field can be a pointer, indicating the position of the segment list to be processed or active. The segments left and segments list fields together determine an Ipv6 DA field. The value of SL field decreases by 1 each time an SRv6 node is passed through and each time the Ipv6 DA is changed once. If the SL value is n, the Ipv6 DA value is calculated based on the value of Segments List [n]. The optional TLV objects field can include the global parameter of all SIDs in the segment list, e.g., a TLV provides metadata for segment processing.

In traditional multicast transmission technologies, e.g., resource reservation protocol (RSVP), multicast label distribution protocol (mLDP), and protocol independent multicast (PIM), transmission is based on Multicast Distribution Tree (MDT, e.g., Shortest-Path Tree (SPT), Rendezvous Point Tree (RPT)), and the MDT can be calculated by control plane computing the tree from the root node to a set of leaf nodes.

In the multicast network, each node (e.g., router) maintains a data forwarding table, and the table may include multiple multicast routing entries. Each multicast routing entry includes four key information: multicast source address, multicast group address, upstream interface, and downstream interface. The multicast routing entry guarantees that the multicast packet is transmitted along the MDT. Multicast routing entries are classified into (S, G) and (*, G). S indicates the address of a multicast source, G indicates the address of a multicast group, and * indicates any multicast source. Each multicast node may maintain different multicast routing entries for different MDTs (i.e., different multicast sources, different multicast group). In the case of a large multicast network (e.g., having many multicast sources and multicast groups), the memory space of the multicast nodes is occupied by the bloated multicast routing entries, thereby leading to weak or inadequate network performance.

In SR multicast transmission technologies, SR-MPLS and SRv6 leverage the similar concept of multicast distribution tree (MDT) to achieve multicast transmission. Tree Segment Identifier (Tree-SID) is a tree-building solution that can be applied to SR-MPLS. Tree-SID uses a single MPLS label for building a multicast replication tree in an SR network. Tree-SID can be also applied to SRv6. Multicast transmission can be also supported by SRv6 Spray. In Spray, the network is divided into the SRv6 domain and the multicast domain. The SIDs in the SRH can specify the unicast-based transmission in the SRv6 domain as well as the group-based transmission in each multicast domain.

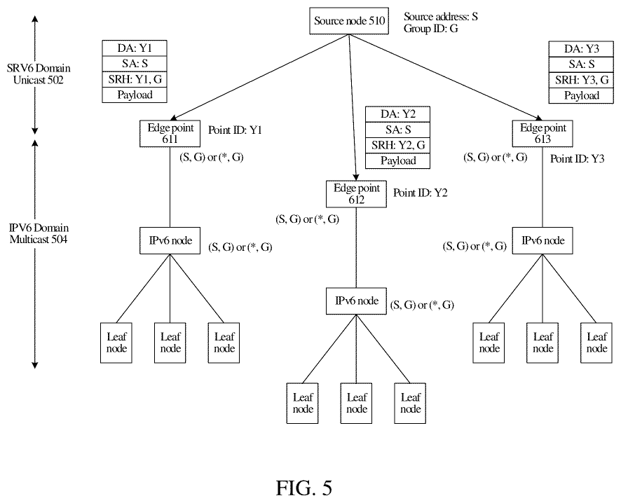

FIG. 5 illustrates an SRv6 spray for multicast transmission. SRv6 spray technique, illustrated in FIG. 5, leverages SRv6 for unicast transport of multicast packet. SRv6 spray uses the ingress replication technology.

As illustrated, edge points are deployed between the SRv6 domain 502 and Ipv6 multicast domain 504. The source node 510 replicates a multicast packet and unicasts the packet to the edge points with SRv6, respectively (e.g., edge point 611, 612, and 613).

The multicast transmission to the receivers starts at the edge (i.e., edge point) of the network. The edge points maintain the multicast routing entry (S, G) or (*, G) for the multicast domain. However, for the SRv6 spray, the multicast transmission is not enabled in the SRv6 domain. Multicast transmission is still based on the multicast routing entry (S, G) or (*, G) in the multicast domain, and MDT needs to be calculated.

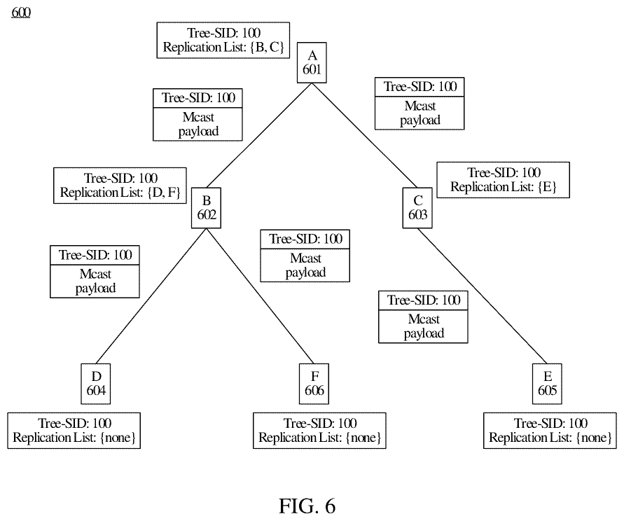

FIG. 6 illustrates Tree-SID in SRv6 and MPLS. An MDT 600 includes nodes A 601, B 602, C 603, D 604, E 605, and F 606 as illustrated. The MDT 600 can be calculated by control plane based on specific policies. Tree-SID (e.g., can be used as MPLS label or SRv6 segment) and replication list are configured to each node in the MDT 600. For example, the tree-SID for MDT 600 is 100. The source node A 601 encapsulates the Tree-SID into the multicast packet, replicates the packet and forwards it to the next-hop nodes (e.g., B 602 and C 603) based on the configured replication List. The next-hop nodes (e.g., B 602 and C 603) replicate the multicast packet and forward it to the receivers (e.g., leaf node, edge router) based on the replication List, as illustrated.

In SR, packets have embedded segment list for traffic steering. The underlay tunnel can be shared by multiple data flows, which may be viewed as consistent with the requirement of the 6G network for mission management. However, current segment routing technology has limitations or shortcoming which may render the technology for 6G networks, as segment routing may be inadequate to achieve per-flow or per-tunnel state inside network.

One of the targets of SR for data forwarding is to ensure that no loop occurs in packet forwarding path. However, in future 6G networks and provision of XaaS, ability to loop data may be needed to perform data processing, e.g., in reference to FIG. 1B, data may need to be forwarded from PF 112 to PF 113 to PF 115 and then back to PF 112 (via PF 117). In some cases, packets (e.g., raw packets, processed packets) may be required to be transferred back and forth between two nodes several times. Thus, ability to loop data is desirable for accommodating data paths in future networks.

Current technologies related to SR for multicast are mainly based on the MDT, e.g., where Tree-SID and replication List are configured to each node in the MDT. In such technologies, each node may maintain different multicast routing entries for different MDTs. In a large multicast network, where a large number of multicast sources and multicast groups exists, an MDT may need to be established for each multicast flow, and each node in the MDT may be required to maintain the multicast status. In such networks, the memory space of the multicast node is occupied by the bloated multicast routing entries, leading to weak performance. In addition, when a new multicast user joins the multicast group, the user needs to be added to the multicast tree, hop by hop, from the edge of the network. Further, Tree-SID & Replication List may need to be to each node in the MDT. As a result, frequent configuration & update may be needed for such networks. Because of these limitations, a flexible and dynamic data forwarding is not enabled. Accordingly, it may be desirable avoid pre-configuration of MDT and replication list.

In 6G network, both data forwarding and data processing should be natively enabled. The data processing configuration may be carried in packet header. The data processing configuration included in the packet header for a node may need to be correctly or appropriately mapped to that node. Fields indicating function and TLV may be encapsulated in packet header, e.g., in SRv6, and may be available for unicast transmission. However, existing technologies has limited or weak scalability in terms of data processing configuration. An existing challenge may be correctly mapping the data processing configuration for specific nodes (e.g., intermediate nodes of a path) to those nodes involving multicast packet. For example, some intermediate nodes connected to an aggregation node, or intermediate nodes in a unicast path may have same BIFT and FBM, and no BFR-ID assigned to them. Determining how to map data processing configuration for these intermediate nodes is yet to be determined.

According to some aspects, loop transmission may be enabled. For example, traffic may be enabled go through the right or appropriate traffic path when the path has forks and aggregations.

Some aspects of the disclosure may obviate the need for pre-configuration procedure of MDT information (e.g., Tree-SID) to the network nodes for SR multicast transmission. Some aspects may enable packet forwarding and replication instruction to be included in packet header, based on which, the network node may further perform correct multicast transmission flexibly and dynamically.

Existing technologies related to SR for data forwarding have limited or weak scalability in terms of data processing configuration. According to some aspects, one or both of data processing configuration and data forwarding configuration (e.g., for intermediate nodes, source or terminal node of a path) may be included in packet header. According to some aspects, data processing configuration and data forwarding configuration for a same node may be appropriately or correctly bound, to be available and efficient for various cases (e.g., unicast, multicast, loop-free, or non-loop-free).

According to an aspect, a number of nodes are involved in a traffic path. A connection may be established between every two network nodes in a path. A path includes one or more connections. A first path may be considered to be different from a second path if the involved network nodes or connections in the first path are different from those of the second path. In some aspects, a connection between two network nodes can be shared by different paths, and two paths may share one or more connections. Different paths connecting a node and some other nodes may be configured as multiple candidate paths.

In some aspects, one or more of: packet header Block Information (BIS) and Fork Indications (FIs) may be encapsulated into the packet header to indicate the traffic path(s). Each BI may be read by a network node in the path(s). In some aspects, BI may be similar to the segment list in SRv6. The nodes in a path(s) may forward the packet, or the processed packet result (both of which may be called packet), hop by hop, based on the BIs and FIs. For example, a current network node may forward a packet to a next-hop network node based on the BIs and FIs.

In some aspects, a Path Selection Information (PSI) may be included in each BI to indicate that the packet need be forwarded by a current network node to the next-hop network node via the path determined by the PSI. In some aspects, the PSI function may be similar to the Locator field of Segment in SRv6.

In some aspects, the FI may indicate that a current path has forked paths, i.e., the packet should be forwarded by a current node to more than one next-hop network nodes, or to one next-hop network node via different Connections.

In some aspects, the PSI can be a Connection ID identifying a Connection between two network nodes. In some aspects, the PSI can be a node ID identifying the next-hop network node, e.g., a node address. In some aspects, the PSI can be a radio link ID (e.g., data radio bearer (DRB) ID, an ID of newly defined Radio Bearer for XaaS e.g., data processing radio bearer (XRB), a logical channel ID (LCID) identifying a radio link, e.g., between a user equipment (UE) and a radio access network (RAN). In some aspects, the PSI can be a path ID identifying a traffic path.

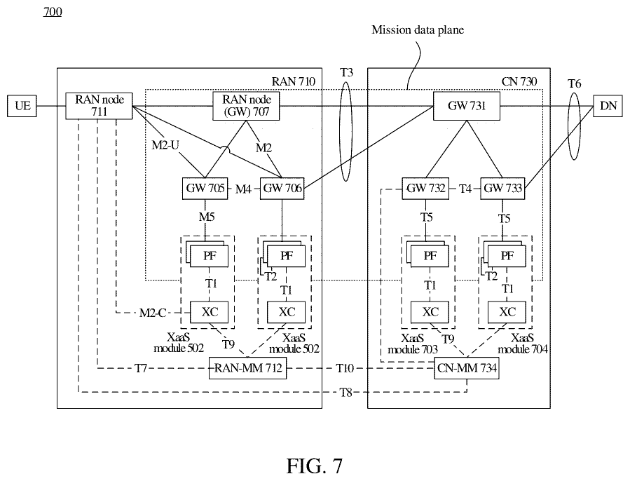

In some aspects, the FI may not be needed in the packet header, e.g., when only one fork point exists in a path, and the next-hop network nodes can be decided only with BIs. In some aspects, the FI may not be needed in the packet header, e.g., when no fork point exists in the path. In some aspects, the packet header can be the IP protocol layer packet header. In some aspects, the network node can be a processing function (PF) of X as a service (XaaS) module, a RAN, a core network (CN), or a UE as described herein including in reference to FIGS. 7, 8 and 9.

In some aspects, a packet header can be a PF protocol layer header. The PF protocol layer may be deployed on top of transport network layer (TNL), e.g., on top of General Packet Radio Service (GPRS) Tunneling Protocol-User Equipment (GTP-U), User Datagram Protocol (UDP), Quick UDP Internet Connection (QUIC), Internet Protocol (IP), or SRv6. In some aspects, the PF protocol layer may be deployed in the PF unit of XaaS module, e.g., deployed in RAN, in UE, etc. In some aspects, the Block Information may be the Module Block Information (MBI), which may be read by one or more PFs of one or more of: XaaS module, RAN, and UE as described herein including in reference to FIGS. 7, 8 and 9.

In some aspects, a packet header can be a protocol layer header, for example, a PF protocol layer header, and the protocol layer may be deployed at one of: on top of the Packet Data Convergence Protocol (PDCP) sublayer, between the Service Data Adaptation Protocol (SDAP) sublayer and the PDCP sublayer, between the PDCP sublayer and the Radio Link Control (RLC) sublayer, between the RLC sublayer and the Media Access Control (MAC) sublayer, between the MAC sublayer and physical layer (PHY), on top of the SDAP sublayer, on top of a protocol data unit (PDU) layer, on top of a GTP-U layer, on top of UDP layer, on top of an IP layer, on top of a QUIC layer, on top of a Hypertext Transfer Protocol (HTTP) layer, on top of a segment routing over IPv6 (SRv6) layer, within the PDU layer, within the SDAP sublayer, within the PDCP sublayer, within the RLC sublayer, within the MAC sublayer, within the PHY layer, within the GTP-U layer, within the UDP layer, within the IP layer, within the application layer, within HTTP layer, within SRv6 layer, and within the QUIC layer.

In some aspects, the packet header may include a Data Aggregation Indication (DAI) to indicate that some data from specific paths should be aggregated at a network node for joint data processing instead of independent data processing.

According to some aspects, the control plane (e.g., mission management function or mission manager (MM) and XaaS service controller (XC)) and data plane (e.g., ingress PF, egress PF) may perform one or more operations to allow data forwarding and processing in paths with forks and without forks. For example, the control plane may generate and program one or more of: BI, FI and DAI to encapsulate and decapsulate packet header accordingly. The MM may control, manage and configure the network to perform a mission, e.g., the MM may control, manage and configure the network functions (e.g., gateway, XaaS module) to establish the resources for executing one or more tasks involved in a mission. As may be appreciated, MM may be named with other terminologies, e.g., mission control function (MCF).

FIG. 7 illustrates an applicable XaaS system architecture, according to an aspect. The system architecture 700 illustrates an example architecture to which one or more aspects of the disclosure may be applicable.

In an aspect, XaaS modules 701 and 702 are deployed at RAN side 710 and Xaas modules 703 and 704 are deployed at CN side 730. The MMs may be deployed according to a hierarchy (e.g., MM hierarchy). In some aspects, system architecture 700 may comprise one or more of global MM and domain MM. In some aspects, the hierarchy may be due to mission hierarchy (e.g., mission under the control of global MM, and submission under the control of domain MM), or due to network administration hierarchy (e.g., RAN and CN). A domain may refer to an administrative domain or a mission management domain. For example, there may be MMs deployed in RAN and CN respectively, i.e., RAN-MM and CN-MM. The global MM and the domain MM can be located in the same network domain or different network domains. For example, both the two MMs (the global and domain MMs) may be located in CN 730, i.e., CN-MMs, or in RAN 710, i.e., RAN-MMs, or one may be located in RAN while the other located in CN.

Each XaaS module may comprise an XaaS service controller (XC) and one or more PFs. An XC may connect with a PF via T1 interface. Some PFs of an XaaS module may be border PFs (e.g., ingress PFs, egress PFs) to connect to external entities.

One or more gateways (GWs) on data plane may be deployed in RAN and CN. In an aspect, a RAN-GW (e.g., GW 705) may connect to a RAN-PF via an M5 interface. In some aspects, a RAN-GW (e.g., GW 705) may connect to another RAN-GW (e.g., GW 706) via an M4 interface. In some aspects, a RAN-GW (e.g., GW 705) may connect to a RAN node 707 via an M2 interface. In some aspects, a RAN-GW (e.g., GW 706) may connect to a CN-GW (e.g., GW 731) via a T3 interface.

In some aspects, a CN-GW (e.g., GW 732) may connect to a CN-PF via a T5 interface. In some aspects, a CN-GW (e.g., GW 732) may connect to another CN-GW (e.g., GW 733) via a T4 interface. In some aspects, a CN-GW (e.g., GW 733 and 733) may connect to a data network (DN) via a T6 interface.

In some aspects, integrated or split RAN node(s) may be deployed at the system architecture 700.

If integrated RAN node is deployed (e.g., central unit (CU) or distributed unit (DU) are not deployed), a RAN node (e.g., RAN node 711) may connect to XC via an M2-C interface. In some aspects, RAN node 711 may connect to a GW (e.g., GW 705) via an M2-U interface. In some aspects, RAN node 711 may connect to a PF via M2-U and M5 interfaces. In some aspects, RAN node 711 may connect to RAN-MM 712 via a Ty interface. In some aspects, RAN node 711 may connect to CN-MM 734 via T8 interface. In some aspects, a RAN node (e.g., RAN node 707) may connect to CN-GW 731 via a T3 interface. In some aspects, RAN node 711 may connect to a user equipment (UE) a via radio link.

If split RAN node is deployed (e.g., CU and DU are deployed), in some aspects, a first split part (e.g., DU) of RAN node 711 may connect to XC via an M2-C interface. In some aspects, the DU of RAN node 711 may connect to GW 705 via M2-U interface. In some aspects, the DU of RAN node 711 may connect to PF via M2-U and M5 interfaces. In some aspects, the DU of RAN node 711 may connect to UE via radio link. In some aspects, a second split part (e.g., CU) of RAN node 711 may connect to XC via an M2-C interface. In some aspects, the CU of RAN node 711 may connect to GW 705 via an M2-U interface. In some aspects, the CU of RAN node 711 may connect to PF via M2-U and M5 interfaces. In some aspects, the CU of RAN node 711 may connect to RAN-MM 712 via a Ty interface. In some aspects, the CU of RAN node 711 may connect to CN-MM 734 via a T8 interface. In some aspects, the CU of RAN node 707 may connect to CN-GW 731 via a T3 interface. In some aspects, RAN node 711 is a DU of a RAN base station, and RAN node 707 is a CU of a RAN base station. In some aspects, RAN node 711 is a DU of a RAN base station. In some aspects, RAN node 707 is a CU of a RAN base station.

In some aspects, a RAN-GW (e.g., GW 706) can connect to CN-GW (e.g., GW 731) directly via a T3 interface, or intermediately (e.g., GW 705) via a RAN node (e.g., RAN node 707).

In some aspects, GWs are optionally deployed. In some aspects, when GWs are not deployed at RAN, the RAN node can connect to a CN-GW directly via a T3 interface.

In some aspects, the PFs (i.e., border PFs and intermediate PFs) within a XaaS module intra-connect via a T2 interface, and PFs (i.e., border PFs) deployed in different XaaS modules inter-connect via GW(s) or directly. For example, on CN side 730, PFs deployed in different XaaS modules can connect with each other via GW(s). On RAN side 710, PFs deployed in different XaaS modules can connect with each other via T2 interface directly. In some aspects, RAN-PFs deployed in different XaaS module can connect with each other via GW(s).

In some aspects, a RAN-PF can connect to CN-GW via the intermediate M5 and T3 interfaces. In some aspects, a RAN-PF can connect to a CN-GW via the intermediate M5, M2 and T3 interfaces. If the GWs are not deployed in RAN, the RAN-PF can connect to CN-GW directly, or via an intermediate RAN node.

In some aspects, an MM (e.g., RAN MM 712 or CN MM 734) may connect to an XC via a T9 interface. In some aspects, hierarchical MMs may connect with each other via T10 interface directly or via one or more intermediate entities. For example, Hierarchical MMs in the same domain (e.g., both in CN) can connect with each other via T10 interface directly, which can be an SBI interface. In some aspects, hierarchical MMs in the same domain (e.g., both in RAN) can connect with each other via a RAN node. In some aspects, hierarchical MMs in the same domain (e.g., both in CN) can connect with each other via connectivity management function (CM). The CM may provide a capability of connectivity management by maintaining connectivity between end-points (e.g., devices, mobiles, terminals) of end customers and the 6G system, e.g., to maintain the reachability and connectivity of end-points for mobility tracking, status update, 6G radio bearer establishment. In some aspects, hierarchical MMs in different domains (e.g., RAN-MM and CN-MM) can connect with each other via a RAN node (i.e., via the intermediate T8 and Ty interfaces), or directly via a T10 interface.

In some aspects, one or more entities illustrated in FIG. 7 can integrated as one entity, e.g., RAN node and XaaS modules on RAN side can be integrated.

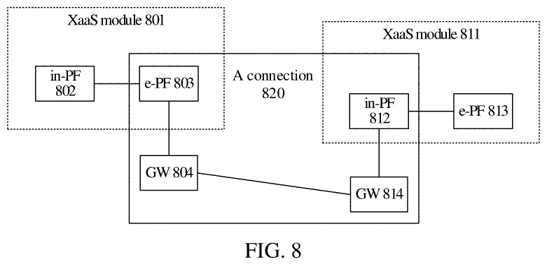

FIG. 8 illustrates a connection between two border processing functions, according to an aspect. XaaS module 801 may comprise two border PFs, ingress PF 802 and egress PF 803. Similarly, XaaS module 811 may comprise two border PFs, ingress PF 812 and egress PF 813. In some aspects, an ingress PF and an egress PF may be the same PF.

An egress PF 803 of XaaS module 801 may connect to an ingress PF 812 of another XaaS module 811 directly or via intermediate entity (e.g., GW 804 and 814). The link between the egress PF 803 of XaaS module 801 and the ingress PF 812 of another XaaS module 811 may be referred to as a connection 820. Connection 820 may include one or more GWs (e.g., GW 804 and 814). In some aspects, connection 820 may not involve GW e.g., when connection 820 is direct between the border PFs.

In some aspects, connection 820 can be the overlay and on top of transport layer, e.g., on top of QUIC connection, GTP-U tunnels, UDP connection, and IP connection. The transport layer is on the top of network layer (e.g., on the top of IP layer).

In an aspect, a new PF protocol layer may be deployed in the system, for example, a PF protocol layer may be deployed on top of TNL, e.g., on top of GTP-U, UDP, QUIC, IP, or Segment Routing over Ipv6 (SRv6) protocol layer. The PF protocol layer can be deployed in the PF unit of an XaaS module, or deployed in RAN, in UE, etc. The connection 820 between the two PFs can be established between two PF entities of a PF protocol layer which can be on top of QUIC, GTP-U, UDP, IP, or SRv6 protocol layer. The mapping between the connection 820 and GTP-U tunnels, UDP connection, IP connection, QUIC connection, and SRv6 connection can be configured. In some aspects, a connection 820 can be identified by a Connection ID.

In some aspects, a packet header can be a protocol layer header, for example, a PF protocol layer header, and the protocol layer may be deployed at one of: on top of the Packet Data Convergence Protocol (PDCP) sublayer, between the Service Data Adaptation Protocol (SDAP) sublayer and the PDCP sublayer, between the PDCP sublayer and the Radio Link Control (RLC) sublayer, between the RLC sublayer and the Media Access Control (MAC) sublayer, between the MAC sublayer and physical layer (PHY), on top of the SDAP sublayer, on top of a protocol data unit (PDU) layer, on top of a GTP-U layer, on top of UDP layer, on top of an IP layer, on top of a QUIC layer, on top of a Hypertext Transfer Protocol (HTTP) layer, on top of a segment routing over IPv6 (SRv6) layer, within the PDU layer, within the SDAP sublayer, within the PDCP sublayer, within the RLC sublayer, within the MAC sublayer, within the PHY layer, within the GTP-U layer, within the UDP layer, within the IP layer, within the application layer, within HTTP layer, within SRv6 layer, and within the QUIC layer.

In some aspects, a connection 820 can be established between two CN-PFs. In some aspects, a connection 820 can be established between. In some aspects, a connection 820 can be established between two RAN-PFs. In some aspects, a connection 820 can be established between a RAN node (e.g., a RAN base station, a RAN-PF) and a CN-PF. In some aspects, one or multiple GWs can be the intermediate entities between the two PFs as part of connection 820.

In some aspects, connection 820 can be established by configuring PF protocol layer parameter and corresponding TNL (Transport Network Layer) parameter to one or more of PFs, GWs and RAN.

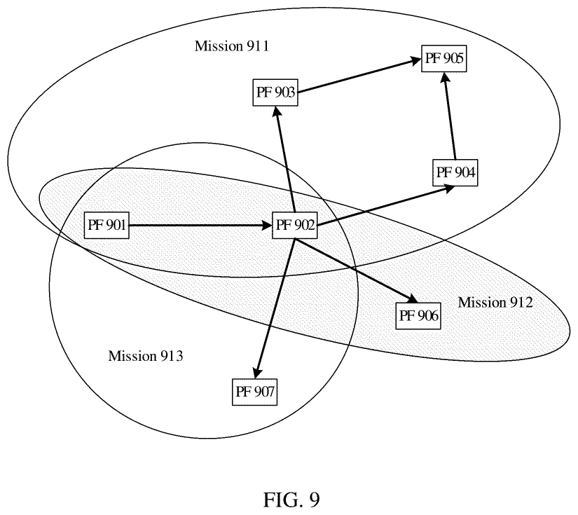

FIG. 9 illustrates PFs involved in multiple missions, according to an aspect. The path between two or more entities (e.g., PF 901 and PF 902) may be the overlapped segment of different missions or submissions. For example, the path between PF 901 and PF 902 is an overlapped segment of a first submission (executed by PF 901, PF 902 and PF 903) and a second submission (executed by PF 901, PF 902 and PF 904) of a same mission 911 (executed by PF 901, PF 902, PF 903, PF 904, and PF 905). The path between PF 901 and PF 902 is also an overlapped segment among mission 911, mission 912 (executed by PF 901, PF 902 and PF 906) and mission 913 (executed by PF 901, PF 902 and PF 907).

A connection on the data plane between two PFs may be established per one or more of: mission, submission, and per UE, under the control of control plane. In existing technologies, for each mission participation (e.g., a UE), the control plane may configure the PFs along the path to establish 4 dedicated connections (e.g., 4 data plane tunnels) between PF 901 and PF 902 for submission 1 of mission 911, submission 2 of mission 911, mission 912 and mission 913, respectively. If multiple UEs participate, the number of connections on the data plane will multiply. As a result, configuration complexity and delay, under the existing technologies, may increase due to, for example, the increased required number of operations (e.g., the control plane sending messages to each of the PFs along the path and configuring them to establish the connections needed to execute the missions).

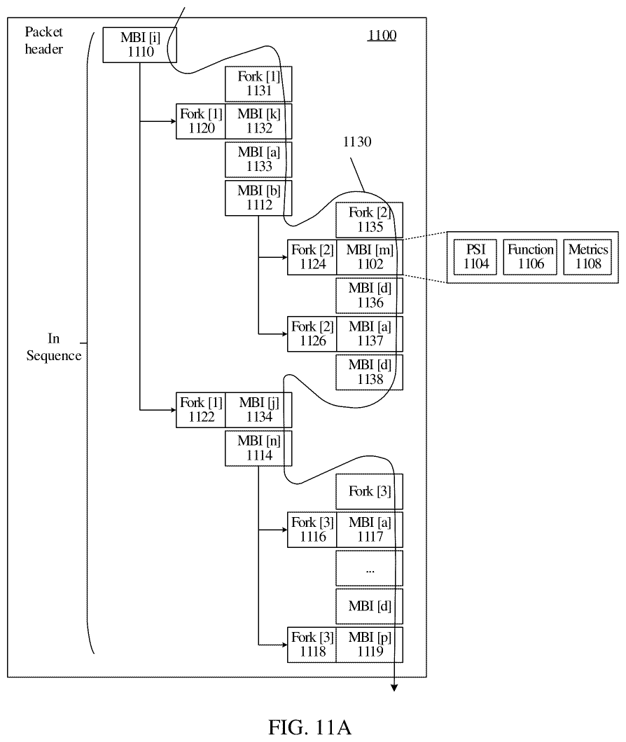

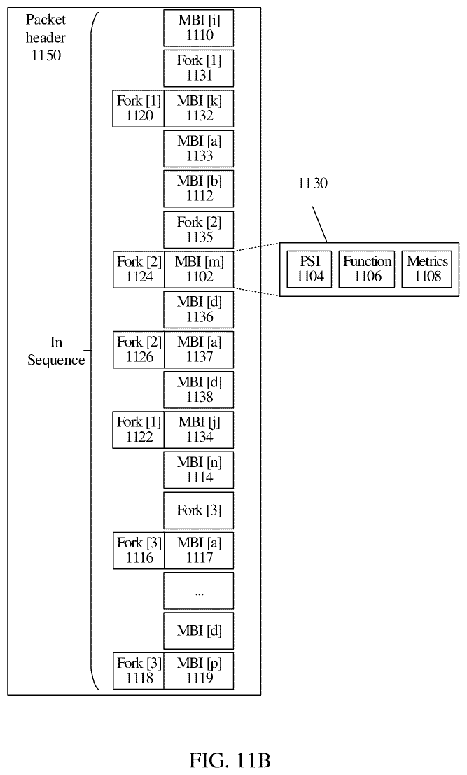

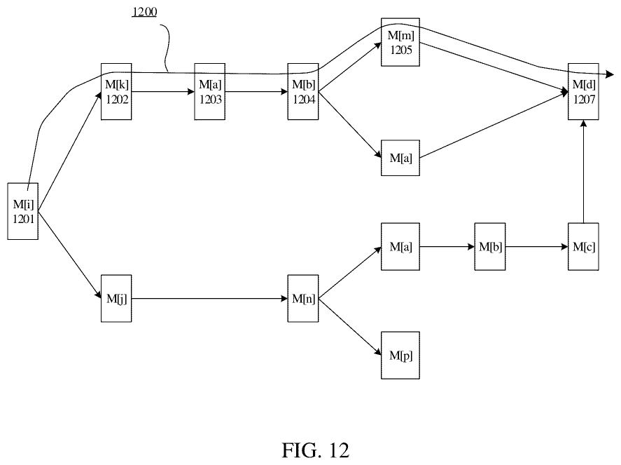

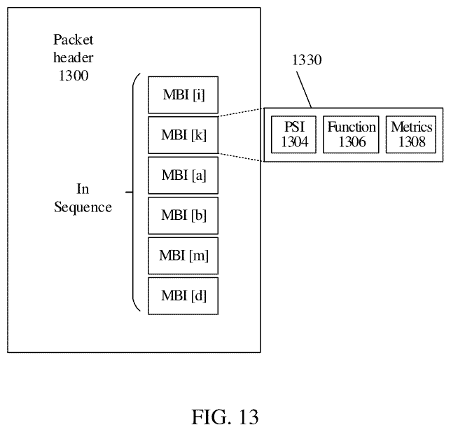

According to an aspect, an SR-based scheme may be provided that may allow for per-flow or per-tunnel traffic steering in loop transmission. The SR-based scheme may be implemented or carried out within, for example, the XaaS system architecture or framework described herein. The SR-based scheme may apply to paths with forks (as described in reference to FIG. FIG. 11A, 11B) or without fork (as described in reference to FIG. 12 and FIG. 13).

According to an aspect, in reference to the XaaS system architecture, a packet header of PF protocol layer may include an MBI (which may be the BI as described herein). In some aspects, the packet header may be read by one or more PFs of: an XaaS module, a network node (e.g., UE, RAN node) deploying the PF protocol layer.

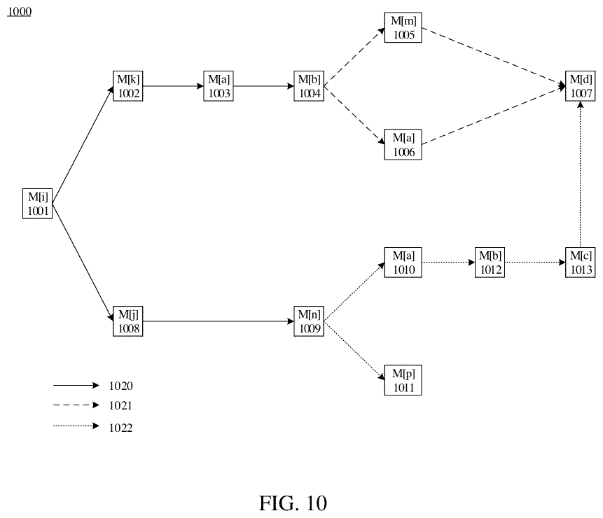

FIG. 10 illustrates a mission comprising multiple paths with forks and an aggregation point, according to an aspect. The execution of mission 1000 may require several traffic paths as indicated, for example, via solid line 1020, dashed line 1021, and dotted line 1022. The traffic path of mission 1000 is illustrated as passing through a plurality of network nodes (i.e., PFs) of modules (XaaS modules). For example, M[i] 1001 may indicate one or more PFs (one or more network nodes) of XaaS module i.

In an aspect, the traffic paths may include fork points (M[i] 1001, M[b] 1004, and M[n] 1007), and aggregation point (M[d] 1007). The traffics from the network nodes (i.e., PFs) of modules M[i] 1001, M[b] 1004 and M[n] 1007 split into two traffics, respectively. The traffic is aggregated at an aggregation point of module M[d] 1007. In some aspects, appearance of a same indexes (e.g., M[a] 1003, M[a] 1006) may indicate a same or different network node (i.e., PF) of a same XaaS module.

In some aspects, an XaaS module including a PF followed by multiple paths may be called a forked module (e.g., M[i] 1001, M[b] 1004, M[n] 1009).

In some aspects, one or multiple PFs (e.g., egress PFs) of a forked module may connect to a same next module. For example, one or more PFs of M[i] 1001 may connect to one or more PFs of M[k] 1002. In some aspects, one or multiple PFs (e.g., egress PFs) of a forked module may connect to different PFs of the next module. For example, multiple PFs of M[i] 1001 may connect to different PFs of M[k] 1002. In some aspects, one or multiple PFs (e.g., egress PFs) of a forked module may connect to the same PFs but via different Connections. For example, one or more PFs of M[i] 1001 may connect to same one or more PFs of M[k] 1002 via one or more different connections.

FIG. 11A illustrates a packet header, according to an aspect. The packet header 1100 may correspond to a PF protocol layer of the XaaS system architecture described in reference to FIGS. 7, 8 and 9. The packet header 1100 is not limited to the PF protocol layer and apply to other protocol layers e.g., in IP layer.

The packet header 1100 may correspond to the mission 1000 as described herein. In some aspects, the packet header 1100 may comprise one or more of: MBI, FI, and DAI.

Each MBI may include information indicating one or more of: PSI, function, and metrics. For example, MBI[m] 1102 may include information indicating PSI 1104, function 1106, and metrics 1108. In some aspects, each MBI may have a plurality of fields indicating one or more of: PSI, function, and metrics. In some aspects, inclusion, in the packet header, of each of the function (e.g., function 1106) and metrics (e.g., metrics 1108) may be optional. In some aspects, one or more MBIs can be in the field Segment List of the SRv6.

In some aspects, the MBIs may be encapsulated in the packet header 1100 in a sequence 1130. The sequence may be based on a rule e.g., according to or in the sequence of the involvement of the XaaS modules in mission 1000. Depending on the sequence, some modules may be skipped. In some aspect, one module's MBI may appear multiple times if the XaaS module participates multiple times, as per the involvement sequence.

In some aspects, the PSI may indicate that the packet need be delivered, by the PF of a current module to the PF of the next module(s), via the path determined by this PSI. In some aspects, the PSI may be a path ID identifying a traffic path. The mapping between the path ID and the Connection from the current PF (e.g., the current XaaS module's egress PF) to the next-hop PF (e.g., the next XaaS module's ingress PF) may be preconfigured to the current PF as in path information (e.g., path table).

In some aspects, the PSI may be a Connection ID identifying a Connection (e.g., overlay of TNL) between current PF (e.g., current XaaS module's egress PF) and the next-hop PF (e.g., the next module's ingress PF). In some aspects, the PSI may be a PF ID (e.g., an IP address, a node ID) identifying the next-hop PF (e.g., the next XaaS module's ingress PF). In some aspects, the PSI may be an XRB ID identifying a radio link between UE and RAN. In some aspects, the PSI of each MBI may include a current PF ID (e.g., an ingress PF ID of a current module, or a current module ID (and the relation between a current module ID and a current PF ID is pre-configured to each PF)) for the current PF to verify whether it is the right receiver.

In some aspects, the PSI included in a forked module's MBI (e.g., MBI[i] 1110, MBI[b] 1112, MBI[n] 1114) may indicate the paths to multiple next-hop destinations. For example, the PSI may include multiple path IDs, multiple Connection IDs, multiple XRB IDs, or PF ID List (e.g., PFs' IP addresses, PFs' IDs). The PSI of a forked module's MBI may indicate that the packet need be forwarded to multiple destinations determined by the PSI when the path branches or splits (e.g., has a fork).

The function (e.g., function 1106) may be used for data processing configuration. The function may indicate the function with which to process the data (i.e., the packet payload) by the PF of a current module. The function may be identified by a Function ID. In some aspects, the function may include a data processing type (e.g., data privacy protection, AI, data sanitization, data normalization, data cleaning etc.). In some aspects, the function may further include a data processing algorithm (e.g., federated learning (FL), generative adversarial network (GAN), K-anonymity, etc.). In some aspects, the function may further include information on one or more of: a mission, submission or task. For example, a Function ID identifying a Function may include or be mapped to a Mission ID identifying a mission, a submission ID identifying a submission, or a task ID identifying a task. In some aspects, the function may be a function list, where the number of functions may correspond to or be the same to that of the current module's involved PFs (e.g., one or more of: ingress and egress PFs).

In some aspects, the metrics (e.g., metrics 1108) may be used for data processing configuration. In some aspects, the metrics may indicate the requirement on data processing (e.g., on processed data result) for a current module. In some aspects, the metrics may include XaaS QoS requirement (e.g., computing accuracy level, privacy level, etc.) on data processing treatment. In some aspects, the metrics may further include one or more parameters for security protection, integrity protection, authentication, etc. In some aspects, the metrics may include format data, e.g., input data format, output format data, etc.

In some aspects, for the first modules following a forked module (e.g., M[a] 1010 and M[p] 1011 are the first modules following forked module M[n] 1009 in FIG. 10), the FI may be encapsulated together with the MBI of each of the first modules (e.g., FI=Fork [3] (e.g., Fork [3] 1116 and Fork [3] 1118) are encapsulated respectively together with the MBIs of M[a] (e.g., MBI[a] 1117) and M[p] (e.g., MBI[p] 1119) as illustrated in FIG. 11.

In some aspects, the FI may be a value which gradually increases (e.g., by one) with each new path fork in the mission data plane. For example, referring to mission 1000, the FI value increase by 1 at the first path fork, being the first fork module M[i] 1001, where each MBI of first modules M[k] 1002 and M[j] 1008 following forked module M[i] are encapsulated with updated FI value, e.g., Fork [1] 1120 and 1122. Similarly, the FI value further increases by 1 at the second path fork, being the second fork module M[b] 1004, where each MBI of first modules M[m] 1005 and M[a] 1006 following forked module M[b] are encapsulated with updated FI value, e.g., Fork [2] 1124 and 1126. Similarly, the FI value further increases by 1 at the third path fork, being the third fork module M[n] 1009, where each MBI of first modules M[a] 1010 and M[p] 1011 following forked module M[n] are encapsulated with updated FI value, e.g., Fork [3] 1116 and 1118.

As may be appreciated, the first modules following a forked module may have an FI of the same value (e.g., FIs of M[a] and M[p] have the same value Fork [3].

The FI following a forked module (e.g., FI Fork [3] following the MBI[n] 1114 (of M[n]) may facilitate packet header decapsulation for a PF. For example, a PF receiving packet 1100 may readily understand that M[n] 1009 is a forked module because of the presence of FI (Fork [3]) following the MBI[n] 1114. Accordingly, the PF may retrieve the forked paths by reading the FI encapsulated together with the MBI[a] 1117 and MBI[p] 1119 (MBIs of first modules M[a] 1010 and M[p] 1011 following M[n] 1009.

In some aspects, the XaaS module including a PF at which data may be aggregated from multiple paths for joint data processing may be called an aggregation module.

In some aspects, DAI may be included in the MBI of the aggregation module. For the aggregation module, e.g., M[d] 1007, DAI can be included in MBI. The DAI may indicate, to a PF of a current module (e.g., the aggregation module M[d] 1007), that the PF needs to aggregate data from specific paths for joint data processing instead of independent data processing.

In some aspects, the DAI can be a string indicating, for example, “aggregate data coming from one or more: path IDs, Connection IDs, PF IDs or XRB IDs”. In some aspects, the DAI may indicate one or more IDs (e.g., specific path IDs, Connection IDs, PF IDs, or XRB IDs) of the paths whose data are to be aggregated.

As may be appreciated, the packet header information indicating MBI, FI, and DAI are not limited to be applicable at the PF protocol layer on top TNL, but rather, may be applicable at other protocol layers, e.g., in IP layer. In some aspects, one or more MBIs can be in or next to the field Segment List of the SRv6. In some aspects, one or more FIs can be in or next to the field Segment List of the SRv6. In some aspects, one or more DAIs can be in or next to the field Segment List of the SRv6. The field Segment List of SRv6 is as described herein including in reference to FIG. 3.

FIG. 11B is another illustration of packet header of FIG. 11A, according to an aspect. Packet header 1150 is similar to packet header 1100 illustrating the MBIs and FIs according to the sequence 1130.

In some aspects, a mission may have a path without a fork or may have one or several path segments without a fork. FIG. 12 illustrates a traffic of a mission without forks, according to an aspect. The mission 1200 may be executed according to a straight data path (e.g., no forks or branches). For example, a straight data path may be the path segment, in FIG. 10, from M[k] 1002 to M[a] 1003 then to M[b] 1004, as this path segment does not have a fork.

In some aspects, since a straight data path does not include a fork or an aggregation point, a corresponding packet (sent according to the straight data path) may not include FI and DAI. A packet sent according to a straight data path may include MBIs encapsulated in a sequence corresponding to the modules involved in the data path (i.e., the data path sequence). For mission 1200, the sequence of modules involved are: M[i] 1201, M[k] 1202, M[a] 1203, M[b] 1204, M[m] 1205, and M[d] 1207.

FIG. 13 illustrates a packet header of a straight data path, according to an aspect. The packet header 1300 may correspond to the mission 1200, as indicated by the sequence of MBIs.

Each MBI may include information indicating one or more of: PSI, function, and metrics. For example, MBI[m] 1302 may include information indicating PSI 1304, function 1306, and metrics 1308. In some aspects, each MBI may have a plurality of fields indicating one or more of: PSI, function, and metrics. In some aspects, inclusion, in the packet header, of each of the function (e.g., function 1306) and metrics (e.g., metrics 1308) may be optional.

In some aspects, the PSI of each MBI may include a path ID, a Connection ID, or a PF ID (e.g., PF node ID, PF IP address) as described herein. In some aspects, the PSI may be a path ID identifying a traffic path. In some aspects, for a straight data path, since the path ID for the different MBIs may be the same, the same path ID may be indicated, in the packet header, outside of the MBIs. In some aspects, only the first MBI may include the path ID, and the subsequent MBIs in the same path may not include the path ID.

In some aspects, the PSI may be a Connection ID identifying a Connection (e.g., overlay of TNL) between a current PF (e.g., current XaaS module's egress PF) and the next-hop PF (e.g., the next module's ingress PF). In some aspects, the PSI may be a PF ID (e.g., an IP address, a node ID) identifying the next-hop PF (e.g., the next XaaS module's ingress PF). In some aspects, the PSI may be an XRB ID identifying a radio link between UE and RAN.

In some aspects, the PSI of each MBI may include a current PF ID (e.g., an ingress PF ID of a current module, or a current module ID (and the relation between the current module ID and the current PF ID is pre-configured to each PF)) for the current PF to verify whether it is the right receiver.

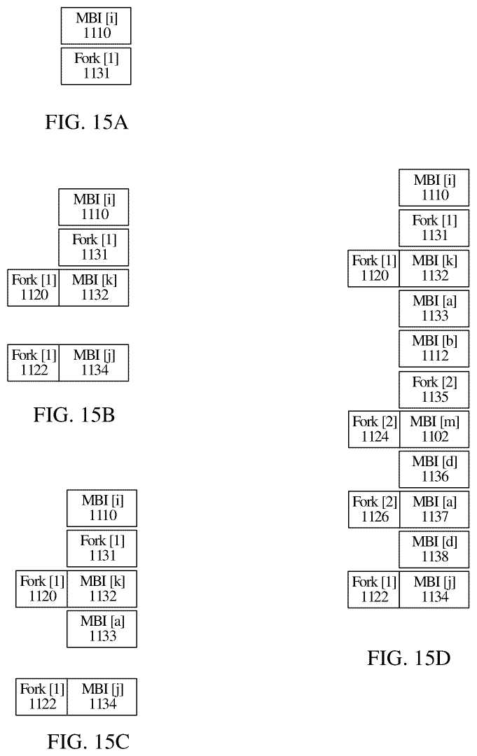

According to an aspect, an SR-based scheme may be provided that may allow for per-flow or per-tunnel traffic steering in loop transmission. The SR-based scheme may be implemented or carried out within, for example, the XaaS system architecture or framework described herein. According to an aspect, the control plane may perform packet information programming, and the data plane may perform packet header encapsulation and decapsulation as described herein. According to an aspect, the packet header information programming and packet header encapsulation and decapsulation may be described in reference to a branching or split data path (a data path that includes one or more forks or branches) as described in reference to FIG. 15 to FIG. 25. According to an aspect, packet header information programming and packet header encapsulation and decapsulation are described herein in reference to a straight data path (does not have a fork).

For a branching or split data path (e.g., a path with one or more forks), the control plane (e.g., MM) may generate data or information indicating one or more of: MBIs, FIs and DAIs of modules involved in the branching or split data path. In some aspects, the generation of DAIs may be optional. The control plane may further program the generated data (e.g., one or more of: MBIs, FIs, and DAIs) into an ordered list. The control plane may further configure the generated data to the first involved PF or UE.

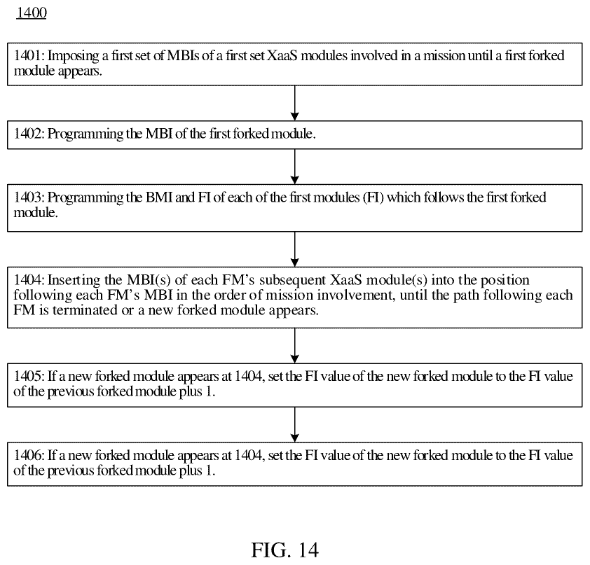

FIG. 14 illustrates a procedure for programming data routing and processing information, according to an aspect. Procedure 1400 may include, at block 1401, imposing or setting, by the control plane (e.g., MM), a first set of MBIs of a first set of XaaS modules involved in a mission until a first forked module appears. The first set of MBIs may be arranged or placed in sequence according to the order of mission involvement of the first set of XaaS modules, where one MBI may be imposed for each XaaS module of the first set of XaaS modules.

In some aspects, block 1401 may include imposing the MBI of the firstly involved XaaS module in the start position of the ordered list. The ordered list comprising a plurality of MBIs and one or more FIs, where the plurality of MBIs correspond to a plurality of modules involved in the mission, and the one or more FIs correspond to one or more forked modules of the plurality of modules. The ordered list of the plurality of MBIs and the one or more FIs arranged according to order of involvement of the plurality of modules.

In some aspects, if the firstly involved XaaS module is not a forked module, the procedure 1400 may further include imposing the MBI's of subsequent XaaS modules in the order of mission involvement until a first forked module appears. The procedure 1400 may further include setting a value to the FI corresponding to the first forked module (e.g., for the first forked module of the mission, an initial value (e.g., 0 or 1) may be set to its FI). Optionally, impose the FI of the forked module in the position following the MBI of the forked module.

The procedure 1400 may further include, at block 1402, the control plane (e.g., MM) programming the MBI of the first forked module. In some aspects, the control plane may impose the FI of the first forked module in the position following the MBI of the first forked module. For example, in reference to mission 1000 of FIG. 10, the first forked module is M[i] 1001. Accordingly, the control plane may program the MBI of the first forked module, e.g., MBI [i] 1110, and optionally impose the FI of the first forked module (e.g., Fork [1] 1131) in the position following the MBI of the first forked module, as illustrated in FIGS. 11A and 11B, and further illustrated in FIG. 15A. FIG. 15A illustrates programming of MBI and FI of a first forked module, according to an aspect.

In some aspects, the procedure 1400 may further include, at block 1403, the control plane (e.g., MM) programming the MBI & FI of each of the first modules (FMs) which follows the first forked module. There may be at least two first modules following the first forked module. For example, in reference to mission 100 of FIG. 10, M[k] 1002 and M[j] 1008 are the first modules of the first forked module M[i] 1001. The value of each FM's FI (e.g., value of Fork [1] 1120 of M[k] and value of Fork [1] 1122 of M[j]) may be same to that of the first forked module's FI (e.g., value of Fork [1] 1131). The procedure 1400 may further include, imposing each FM's FI & MBI in sequence in the position following the MBI of the first forked module, as illustrated in FIG. 15B. FIG. 15B illustrates further programming of MBI and FI after the programming of FIG. 15A, according to an aspect.

In some aspects, the order of the different FMs' FIs & MBIs may be consistent with the order of the Connection IDs, PF IDs or XRB IDs in the MBI of the first forked module, as illustrated in FIG. 15B.

In some aspects, procedure 1400 my further include, at block 1404, the control plane (e.g., MM) inserting the MBI(s) of each FM's subsequent XaaS module(s) into the position following each FM's MBI in the order of mission involvement, until the path following each FM is terminated or a new forked module appears. For example, in reference to mission 1000 of FIG. 10, the XaaS module(s) following M[k] 1002 (being an FM after the first forked module M[i] 1001) until the path is terminated or new forked module appears includes M[a] 1003, since the M[b] 1004 is a forked module. Thus, MBI of M[a] 1003 (e.g., MBI[a] 1133) may be positioned following MBI[k] 1132, as illustrated in FIGS. 11A, 11B, and 15C. FIG. 15C illustrates further programming of MBI and FI after the programming in FIG. 15B, according to an aspect.

For the other FM, M[j] 1008, (being another FM after the first forked module M[i] 1001) the subsequent XaaS module is a forked module, M[n] 1009. Accordingly, at this stage in the procedure no further MBI is positioned after the MBI of M[j] (e.g., MBI[j] 1134) as illustrated in FIGS. 11A, 11B, and 15C.

In some aspects, procedure 1400 may further include, at block 1405, if a new forked module (e.g., second forked module) appears, e.g., at block 1404, set the FI value of the new forked module (e.g., FI_{[second forked module]}) to the FI value of the previous forked module (e.g., FI_{[first forked module]}=Fork [1]) plus 1, thus, FI_{[second forked module]}=FI_{[first forked module]}+1. For example, in reference to mission 1000, M[b] 1004 may be considered a new forked module (e.g., a second forked module) appearing on the path from M[k] 1002. Accordingly, the FI corresponding to M[b] 1004 may be set to the FI value of a previous forked module, e.g., Fork [1], plus 1: Fork [2]=Fork [1]+1.

In some aspects, procedure 1400 may further include, at block 1406, if a new forked module appears, e.g., at block 1404, repeating the operations performed at block 1402 to block 1405, starting from the new forked module until the path(s) following the new forked module are terminated.

For example, similar to operations at block 1402, in reference to mission 1000 of FIG. 10, the control plane (e.g., MM) may program the MBI of the second forked module (e.g., MBI[b] 1112). The control plane may further impose the FI of the second forked module, Fork [2] 1135 in the position following MBI[b] 1112 as illustrated in FIG. 11A, 11B and FIG. 15D. FIG. 15D illustrates further programming of MBI and FI, after the programming in FIG. 15C, according to an aspect.

Thereafter, similar to operations at block 1403, the control plane may program the MBI and FI of each FMs following the second forked module. An FM following the second forked module may be M[m] 1005, and the other FM following the second forked module may be M[a] 1006, as per mission 1000 of FIG. 10. The FI value of each FM (e.g., Fork [2] 1124 corresponding to M[m], and Fork [2] 1126 corresponding to M[a]) following the second forked module may be the same as the FI value of the second forked module (e.g., Fork [2] 1135). Thereafter, each FM's FI and MBI may be imposed in sequence in the position following the MBI of the second forked module (and the FI of the second forked module), as illustrated in FIGS. 11A, 11B, and 15 D. Further, similar to operations at block 1404, the control plane (e.g., MM) may insert the MBI(s) of each FM's subsequent XaaS module(s) into the position following each FM's MBI in the order of mission involvement, until the path following each FM is terminated or a new forked module appears. For both M[m] 1005 and M[a], the subsequent module is M[d] 1007. Accordingly, the MBI[d] 1136 and MBI[d] 1138 may be positioned following each FM's MBI (e.g., MBI[m] 1102 and MBI[a] 1137) as illustrated in FIG. 11A, 11B, and FIG. 15D.

In some aspects, for different forked paths of a forked module, the MBIs, FIs and (optional) DAIs along different forked paths can be programed path by path. For example, the MBIs, FIs and (optional) DAIs along a first forked path may be programed until the first forked path is terminated. Then, the MBIs, FIs and (optional) DAIs of a second forked paths (of different forked paths) may be programed until the second forked path is terminated. Similarly, the MBIs, FIs and (optional) DAIs of any further forked paths (of different forked paths) may be programmed until the further forked paths are terminated. The programming of each forked path may be done, for example, according to the programming procedure 1400 described herein.

With respect to mission 1000, after the first forked path (e.g., the forked path following M[k] 1002) is terminated, the control plane (e.g., MM) may start to program one or more of: MBI, FI, DAI of the second forked path (i.e., the forked path following M[j] 1008) until the second forked path is terminated. Taking the programing approach of path by path as example, the programmed routing and processing data or information (indicating one or more of: MBI, FI, DAI) may result in the illustrated FIG. 11B.

The programming of the forked paths is not limited to one-by-one programming. In some aspects, the programing of the different forked paths may be done in parallel. According to an aspect, an FI value range (the range may be wide enough to accommodate the number of forked paths) may be assigned to each parallel programming. Different parallel programming may have different FI value range. The first FI in each parallel programming may be set as the smallest value of the assigned range. And the subsequent FIs in each respective parallel programming may be increased incrementally. If the increased value of FI exceeds the assigned range (a small probability, but not impossible) in a parallel programing, the parallel programming feedbacks an alarm to request for additional FI value range.

In some aspects, during the procedure 1400, if a module is an aggregated module, e.g., M[d] 1007, the DAI should be included in the MBI of the module.

In some aspects, if a node is shared by different paths, and the shared node is not a data aggregation node (i.e., the traffics of different paths pass through the shared node independently), the MBIs (e.g., PSIs) along the paths after the shared node may be duplicated in the different paths.

In some aspects, if a node is shared by different paths, and the shared node a data aggregation node (i.e., the traffics of different paths are aggregated by the shared node when they pass through the shared node, e.g., M[d] 1007), the MBIs (e.g., PSIs) along the paths after the shared node may be retained in one of the different paths.

In some aspects, to generate the MBIs, the control plane (e.g., MM) may interact with XC. For example, the control plane (e.g., MM) may interact with XC to get the one or more of: PF ID, Connection ID, path ID, XRB ID, to be included in the PSI of the MBI.

In some aspects, each PF of a current module may perform data processing and data forwarding based on the corresponding MBI indicated in a received packet header.

In some aspects, when a DAI is included in an MBI, the ingress PF of a current module (e.g., M[d] 1007) may buffer the received data from a first path (of the plurality of paths indicated by the DAI) to wait for data coming from the other paths indicated by the plurality of paths indicated by DAI. After all relevant data is received from the plurality of paths indicated by the DAI, the ingress PF of the current module may jointly process the received data

In some aspects, an egress PF of a current forked module, e.g., M[i] 1001, may forward data (including retained packet header and payload) to each of the different destinations of next hop, e.g., M[k] 1002 and M[j] 1008, respectively.

In some aspects, the firstly involved PF or UE (for example, the first involved PF for downlink traffic, the UE or the first involved PF for the uplink traffic) may encapsulate MBIs, FIs (and DAIs if necessary) into a packet header under the control of one or both of: XC and MM. The firstly involved PF may be an ingress PF of a XaaS module.

In some aspects, when a packet is being forwarded by a current module to a next module, where the current module is a module without fork, the egress PF of the current module may remove the current module's MBI. The ingress PF and the intermediate PFs of the current module may not remove the MBI.

In some aspects, when a packet is being forwarded by a current module to a next module, where the current module is a module with fork (i.e., a forked module): the egress PF of the forked module may perform packet header decapsulation according to different methods.

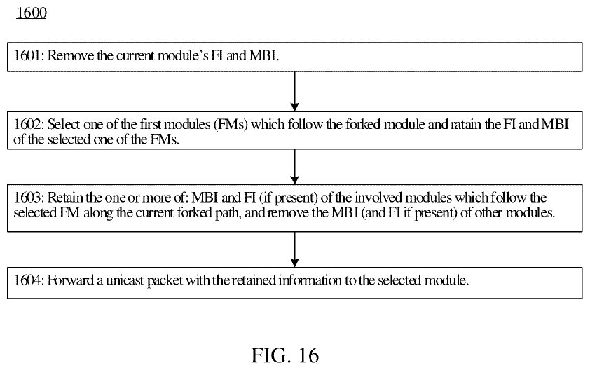

The egress PF of the forked module may perform packet header decapsulation according to a first method as illustrated in FIG. 16. FIG. 16 illustrates a first method for packet header decapsulation, according to an aspect. The method 1600 may apply to a current module being a forked module forwarding a packet to a next module.

In some aspects, according to the first method 1600, the egress PF of the current module (being a forked module) may remove the useless MBIs & FIs and retain the useful MBIs & FIs. That is, at block 1601, the egress PF of the current module may remove the current module's FI & MBI. In some aspect, according to the first method 1600, at block 1602, the egress PF of the current module may further select one of the first modules (FMs) which follow the forked module (the current module) and retain the FI & MBI of the selected one of the first modules. In some aspects, according to the first method, at block 1603, the egress PF of the current module may further retain the one or more of: MBIs (and FI if present) of the involved modules which follow the selected first module (FM) along the current forked path, and remove the FI & MBI of the other modules. In some aspects, according to the first method, at block 1604, the egress PF of the current module may send a unicast packet to the ingress PF of the selected FM. In some aspect, according to the first method, for each next-hop PF of each of the forked paths (i.e., multiple next-hop PFs of one or multiple XaaS modules may exist), the egress PF of the current forked module may further perform similar corresponding operations as described and forward a unicast packet corresponding to the retained packet header to each next-hop PF, respectively.

For example, according to the first method, the egress PF of the current forked module may, in reference to block 1601, retrieve the MBIs &FIs of the first modules via reading the FIs, where the value of the FIs of the FMs are the same to that of the current forked module. For example, in reference to FIG. 15B and mission 1000 of FIG. 10, an egress PF of the current forked module (e.g., M[i] 1001) may retrieve the MBIs and FIs of the first modules (e.g., MBI[k] 1132, Fork [1] 1120, and MBI[j] 1134 and Fork [1] 1122).

In some aspects, according to the first method, after the MBIs &FIs of the first modules are retrieved, the egress PF may, in reference to block 1602 and 1603, select one of the first modules, and retain the FIs and MBIs of the selected first module and its subsequent modules. In some aspects, there may be multiple next-hop destinations (i.e., multiple next-hop PFs of one or multiple XaaS modules). In some aspects, according to the first method, the egress PF may decide which destination the retained MBIs & FIs should be sent to. In some aspects, according to the first method, the destination may be decided, e.g., based on the PSI of the current forked module and the sequence of the FIs & MBIs of the first modules in the packet header. For example, the sequence of the multiple path IDs, Connection ID or PF IDs in the PSI of the current forked module may be same to the sequence of the FIs & MBIs of the first modules in the packet header.

In some aspects, according to the first method, in reference to block 1603, the MBIs (and FIs if present) of the involved modules which follow the selected first module along the current forked path can be retrieved, e.g., based on the value FI. For example, all those MBIs (and FIs if present) following the MBI & FI of the selected first module may include the MBIs (and FIs if present) of the involved modules which follow the selected first module along the current forked path, until an FI exists whose value equals to the FI value of current forked module.

For example, in reference to FIG. 15D and mission 1000 of FIG. 10, the egress PF of the current forked module, M[i] 1001, may select M[k] 1002 as the selected first module, and retain the MBIs and FIs of the selected first module and its subsequent modules, until an FI exits, referring to Fork [1] 1122, whose value equals the FI value of the current forked module, referring to Fork [1] 1131, as illustrated in FIG. 15D.

In some aspects, according to the first method, the egress PF of the current module should or may send multiple unicast packets (with different packet header but duplicated payload) to the multiple ingress PFs of the next-hop module(s), respectively.

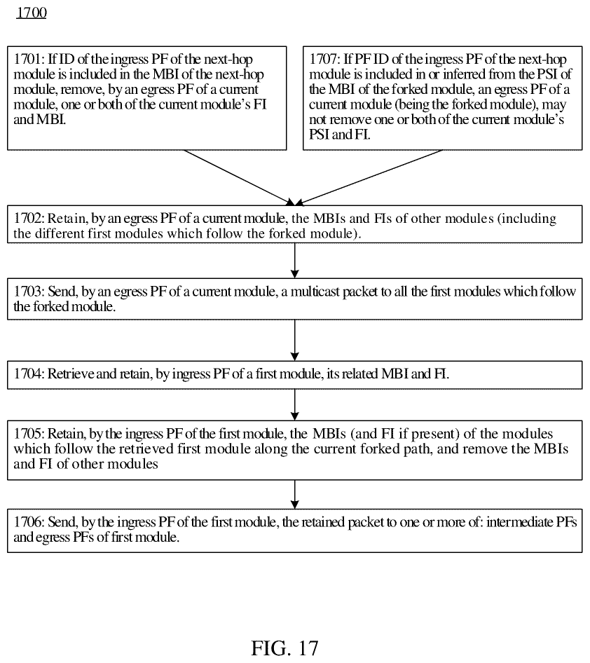

In some aspects, when a packet is being forwarded by a current module to a next module, where the current module is a module with fork (i.e., a forked module): the egress PF of the forked module may perform packet header decapsulation according to a second method, as illustrated in FIG. 17.

FIG. 17 illustrates a second method for packet header decapsulation, according to an aspect. In some aspects, according to the second method 1700, if the ID (e.g., address, node ID) of the ingress PF of the next-hop module is included in the MBI of the next-hop module, at block 1701, the egress PF of the current module (being a forked module) may remove one or both of: MBI and FI of the current module. In some aspects, according to the second method 1700, at block 1702, the egress PF of the current module may further retain the MBIs and FIs of other modules (including the different first modules which follow the forked module). In some aspects, according to the second method 1700, at block 1703 the egress PF of the current module may further send a multicast packet to all the first modules which follow the forked module. In some aspects, according to the second method 1700, at block 1704, the ingress PF of each of the first modules may retrieve and retain its related MBI & FI. In some aspects, according to the second method 1700, at block 1705, the ingress PF of each of the first modules may further retain the MBIs (and FI if present) of the modules which follow the retrieved first module along the corresponding current forked path, and may remove the MBIs and FI of other modules. In some aspects, according to the second method 1700, at block 1706, the ingress PF of each of the first modules may send the retained packet header to the intermediate PFs of the XaaS module (the respective first module corresponding to the ingress PF) along current forked path (the corresponding current forked path) and then to the egress PF of the XaaS module.

In some aspects, according to the second method, if the PF ID (e.g., address, node ID) of the ingress PF of the next-hop module is included in the PSI of the MBI of the forked module, or the PF ID can be inferred from the PSI (e.g., Connection ID) of the forked module, at block 1707, the egress PF of the current module (being the forked module) may not remove one or both of: the current module's MBI and FI. In some aspects, according to the second method 1700, at block 1702, the egress PF of the current module, may further retain the MBIs and FIs of other modules (including the different first modules which follow the forked module). In some aspects, according to the second method 1700, the retaining of the MBIs and FIs of the other modules may be done at the same time as removing the one or both of: the MBI and FI of the current module. In some aspects, according to the second method 1700, at block 1703, the egress PF of the current module may further send a multicast packet to all the first modules which follow the forked module. In some aspects, according to the second method 1700, at block 1704, the ingress PF of each of the first modules may retrieve and retain its related MBI & FI. In some aspects, according to the second method 1700, at block 1704, the ingress PF of each of the first modules may further retain the MBIs (and FI if present) of the modules which follow the retrieved first module along the corresponding current forked path, and remove the MBIs and FI of other modules. In some aspects, according to the second method 1700, at block 1707 the ingress PF of each of the first modules may further send the retained packet header to the intermediate PFs of the XaaS module (the respective first module corresponding to the ingress PF) along current forked path (the corresponding current forked path) and then to the egress PF of the XaaS module.

In some aspects, according to the second method 1700, if the ID (e.g., address, node ID) of the ingress PF of the next-hop module is included in the MBI of the next-hop module, in reference to block 1704, the ingress PF of each first module can retrieves the MBI & FI of this first module, e.g., via reading the FI and the ingress PF ID (e.g., address, node ID) included in the MBI.

In some aspects, according to the second method, if the PF ID (e.g., address, node ID) of the ingress PF of the next-hop module is included in the PSI of the MBI of the forked module, or the PF ID can be inferred from the PSI (e.g., Connection ID), in reference to block 1704, the ingress PF of each first module can retrieves the MBI & FI of this first module, e.g., based on the PSI of the current forked module and the sequence of the FIs & MBIs of the first modules in the packet header. For example, the sequence of the multiple PF IDs included in (or multiple PF IDs inferred from) the PSI of the forked module may be the same as the sequence of the FIs & MBIs of the first modules in the packet header.

In some aspects, according to the second method, after each first module's MBI & FI are retrieved by the ingress PF, in reference to block 1705, the ingress PF should retain the MBI & FI, and its subsequent modules' MBI(s) (and FI(s) if present) along the current forked path, and remove the other modules' FI(s) & MBI(s).

In some aspects, according to the second method, the subsequent modules' MBI(s) and (optional) FI along the current forked path can be retrieved, e.g., based on the value FI. For example, all those MBIs (and FIs if present) following the FI & MBI of the retrieved first module should be its subsequent modules MBI(s) (and FI(s) if present) along the current forked path, until an FI exists whose value equals to the FI value of the retrieved first module.

In some aspects, according to the second method 1700, in reference to block 1703, the egress PF of current module may send a multicast packet to the multiple ingress PFs of the next-hop module(s).

The one or more operations described in reference to the first method 1600 and the second method 1700 may be applied not only to the PF protocol layer e.g., on top of TNL, but also to the traditional IP protocol layer, e.g., when the one or more of: MBI, FIs, and DAI, are encapsulated in IP packet header.

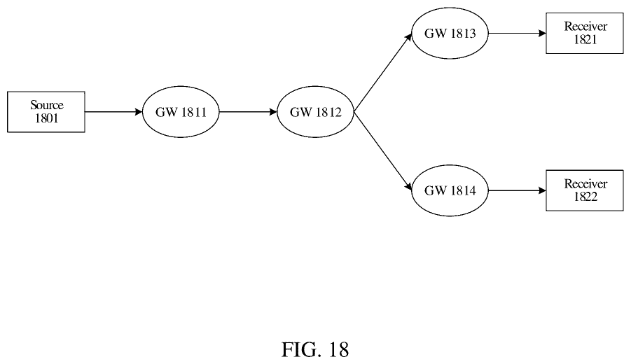

FIG. 18 illustrates a source node sending data to receivers, according to an aspect. The source node 1801 may send data (e.g., a data packet) to one or both of: receiver 1821 and receiver 1822, via one or both of a unicast method (according to the first method 1600) and a multicast method (e.g., according to the second method 1700). The source node 1801 may be an egress PF of an XaaS module, the receiver nodes 1821 and 1822 may be the ingress PFs of another two XaaS modules, and the GWs 1811, 1812, 1813 and 1814 may be routers.

According to the first method 1600, the source node 1801 (and the GWs 1811, 1812) may send two unicast packets (with different packet header but duplicated payload) to the two receivers 1821 and 1822, respectively. In some aspects, according to the first method, the source node 1801 may perform the packet header decapsulation (e.g., perform one or more operations performed by the egress PF of a current forked module as described in reference to the first method 1600) before sending unicast packets as described herein in reference to first method 1600.

According to the second method 1700, the source node 1801 and GW 1811 may need to send a multicast packet to the two receivers 1821 and 1822 (as per one or more operations performed by the egress PF of a current forked module). That is, source node 1801 and GW 1811 may send the packet once. In some aspects, GW 1812 may need to replicate the packet to edge GW 1813 and GW 1814, respectively. The edge GW 1813 and GW 1814 may forward the packet to the two receivers 1821 and 1822, respectively. After the two receivers receive the packet, the receivers may perform the packet header decapsulation (e.g., perform one or more operations performed by the ingress PF of the first module as described in reference to the second method 1700) as described herein in reference to the second method 1700.

In some aspects, the first method 1600 and the second method 1700 may be performed independently. In some aspects, when the MBI, FIs (and optional DAI) are encapsulated in IP packet header by the source node 1801, the first method 1600 and the second method 1700 may be performed jointly (or independently). For example, the source node 1801 and GW 1811 may send a multicast packet to GW 1812 as per the second method 1700. In some aspects, GW 1812 may forward a unicast packet to the receiver 1821, via GW 1813, and forward a second unicast packet to receiver1822, via GW 1814, as per the first method 1600, respectively. Source 1801 and GW 1811 may perform the packet header decapsulation and forwarding the packet as described herein in reference to the second method 1700. GW 1812 and GW 1813 and GW 1814 may perform the packet header decapsulation and forwarding the packet as described herein in reference to the second method 1600. Forwarding the packet according to the first method 1600 and the second method 1700, jointly, may reduce the traffic load between the source node 1801, GW 1811 and GW 1812. In some aspects, GW 1813 and 1814 or the two receivers 1821 and 1822 may perform the packet decapsulation.

As may be appreciated, by using the second method 1700, the packet payload transmission, from source node 1801, to GW 1811, and further to GW 1812, may be reduced, however, additional packet header information may be transmitted. In some aspects, if the size of the packet header is small, the traffic load between the involved network entities may be reduced under the second method 1700, however, the ingress PF of next-hop may perform additional actions (e.g., one or more operations described in reference to block 1704, 1705 and 1706) when compared with the first method 1600.

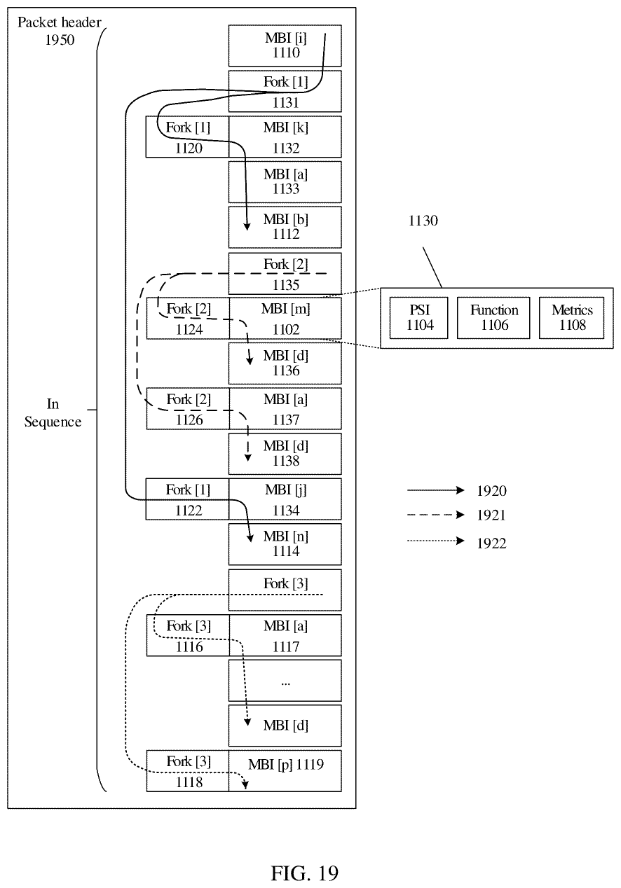

FIG. 19 illustrates MBIs and FIs included a packet header corresponding to path segments of FIG. 10, according to an aspect. In an aspect, the packet header 1950 may be similar to packet header 1150. Packet header 1950 illustrates MBIs and FIs of corresponding path segments of FIG. 10. The MBIs and FIs of path segment 1020 of FIG. 10 is illustrated via solid lines 1920. Similarly, the MBIs and FIs of path segment 1021 of FIG. 10 are illustrated via dashed lines 1921. The MBIs and FIs of path segment 1022 of FIG. 10 are illustrated via dotted line 1922.

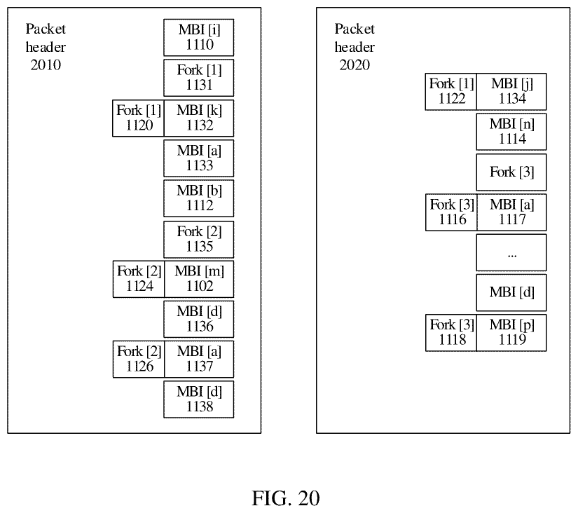

According to an aspect, transmission of a packet in mission 1000 is described. In an aspect, transmission of packet, including a packet header comprising data indicating MBIs and FIs, is described in reference to the first method 1600. In an aspect, the nodes (e.g., PFs) involved in mission 1000 may transmit a packet according to the first method 1600, as described in reference to FIGS. 20, 21, and 22.

FIG. 20 illustrates the packet headers received, via method of FIG. 16, by M[k] and M[j] of FIG. 10, according to an aspect. In an aspect, an egress PF of M[i] 1000 may send, according to the first method 1600, a unicast packet including a packet header 2010 to M[k] 1002. The egress PF of M[i] 1000 may further send, according to the first method 1600, a unicast packet including a packet header 2020 to M[j] 1008. As may be appreciated, the packet header 1950, 1150 and 1100 may comprise similar MBI and FI information as the combination of packet headers 2010 and 2020.

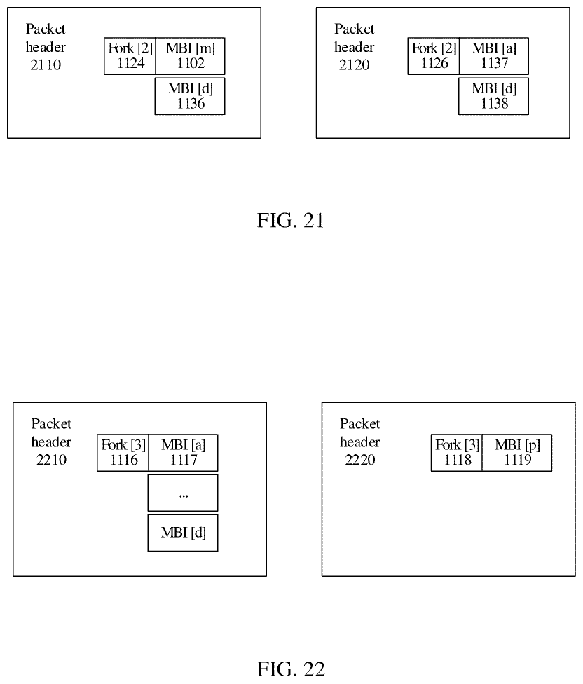

FIG. 21 illustrates the packet headers received, via method of FIG. 16, by M[m] and M[a] of FIG. 10, according to an aspect. In an aspect, after receiver the packet header 2010, M[k] 1002 and M[a] 1003 may forward the packet header according to the method described for transmitting packet along a straight path (a path without a fork). For example, each of the M[k] 1002 and M[a] 1003 may remove its MBI (and FI if present) from the packet header 2010 and retain the subsequent modules' MBIs (and FI if present) and send a unicast packet to its next hop until reaching M[b] 1004. Similarly, M[j] may remove its MBI and FI from the packet header 2020, retain the subsequent modules' MBIs (and FI if present), and send a unicast packet to M[n] 1009.

In an aspect, M[b] 1004 may send, according to the first method 1600, a unicast packet including packet header 2110 to M[m] 1005. M[b] 1004 may further send, according to the first method 1600, a unicast packet including packet header 2120 to M[a] 1006.

FIG. 22 illustrates the packet headers received, via method of FIG. 16, by M[a] and M[p] of FIG. 10, according to an aspect. In an aspect, after receiving the packet header from M[j] 1008, M[n] 1009 may send, according to the first method 1600, a unicast packet including packet header 2210 to M[a] 1010. M[n] 1009 may further send, according to the first method 1600, a unicast packet including packet header 2220 to M[p] 1011.

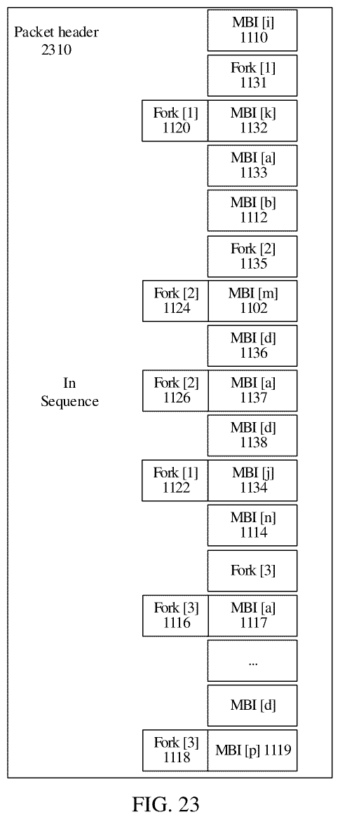

According to an aspect, transmission of a packet according to the second method 1700 is described. In an aspect, the nodes (e.g., PFs) involved in mission 1000 may transmit a packet according to the second method 1700, as described in reference to FIGS. 23, 24, and 25.

As described in reference to the second method 1700, in some aspects, e.g., in reference to block 1707, the PF ID (e.g., address, node ID) of the ingress PF of the next-hop module may be included in the PSI of the MBI of the forked module, or the PF ID can be inferred from the PSI (e.g., Connection ID). Aspects described in reference to FIGS. 23, 24 and 25 may be based on the scenario of block 1707, where the egress PF of a current module (being the forked module) may retain the current module's PSI (or MBI) and FI in the packet header sent to and received by the first modules which follow the forked module.

If the ID (e.g., address, node ID) of the ingress PF of the next-hop module is included in the MBI of the next-hop module, e.g., as described in reference to block 1701, the, the egress PF of a current module (being the forked module) may remove one or both of the current module's FI and MBI from the packet header sent to and received by the first module which follow the forked module.

FIG. 23 illustrates the packet header received, via method of FIG. 17, by M[k] and M[j] of FIG. 10, according to an aspect. In an aspect, an egress PF of M[i] 1000 may send, according to the second method 1700, multicast packet including a packet header 2310 to M[k] 1002 and M[j] 1008. The packet header 2310 may comprise similar MBI and FI information as packet header 1950, 1150 and 1100.

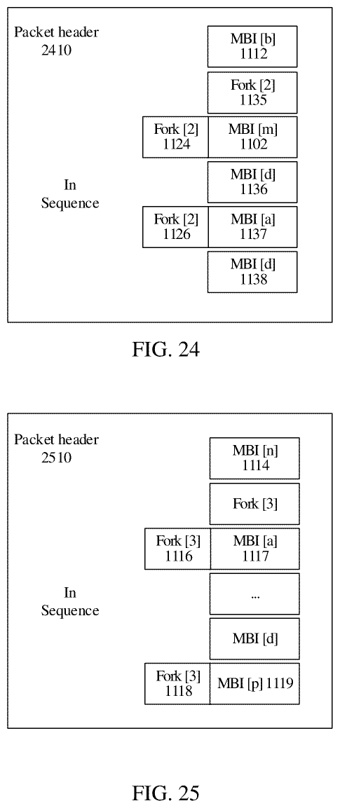

FIG. 24 illustrates the packet headers received, via method of FIG. 17, by M[m] and M[a] of FIG. 10, according to an aspect.

In an aspect, after receiver the packet header 2310, M[k] 1002 and M[a] 1003 may forward the packet header according to the method described for transmitting packet along a straight path (a path without a fork). For example, each of the M[k] 1002 and M[a] 1003 may remove its MBI (and FI if present) from the packet header 2310 and retain the subsequent modules' MBIs (and FI if present) and send a unicast packet to its next hop until reaching M[b] 1004. Similarly, M[j] may remove its MBI and FI from the packet header 2310, retain the subsequent modules' MBIs (and FI if present), and send a unicast packet to M[n] 1009.

In an aspect, M[b] 1004 may send, according to the second method 1700, multicast packet including packet header 2410 to M[m] 1005 and M[a] 1006.

FIG. 25 illustrates the packet headers received, via method of FIG. 17, by M[a] and M[p] of FIG. 10, according to an aspect. In an aspect, after receiving the packet header from M[j] 1008, M[n] 1009 may send, according to the second method 1700, multicast packet including packet header 2510 to M[a] 1010 and M[p] 1011.

For a straight data path (a path without a fork) of a mission, the control plane (e.g., MM) may generates data indicating one or more MBIs for one or more modules involved in the straight data path. In some aspects, the control plane (e.g., MM) may program the generated MBIs into an ordered list, e.g., based on the sequence of the XaaS modules involved in executing the tasks in the mission. The control plane may further configure the ordered list of MBIs to a firstly involved PF or UE.

In an aspect, the firstly involved PF or UE (for example, the first involved PF for downlink traffic, the UE or the first involved PF for the uplink traffic) of the straight data path may perform packet header encapsulation. Packet header encapsulation may include encapsulating MBIs into a packet header under the control of XC and/or MM. In some aspects, the firstly involved PF can be an ingress PF of an XaaS module.

In some aspects, when a packet is being forwarded by a current module to next module, in a straight data path, the egress PF of the current module may remove the current module's MBI and retains the subsequent modules' MBIs.

In some aspects, for a straight data path, the ingress PF of a XaaS module does not remove the MBI. In some aspects, the egress PF of the current module may not remove the current module's MBI, and the ingress PF of the next-hop module may remove the previous module's MBI (i.e., the current module's MBI).

In a straight data path, each PF of a current module may perform one or both of: data forwarding and data processing based on the current module's MBI. In some aspects, each PF may include the processed data in the packet payload to be forwarded.

According to an aspect, a procedure 2600 is provided for the control plane to configure, at one or more PFs, one or more of: MBI, FI and DAI. In some aspect, the procedure 2600 may further provide for the data plane to execute a mission. According to an aspect, the one or more PFs of an XaaS module involved in the procedure 2600 may comprise one or more of: an ingress PF and an egress PF. For example, in some aspects, the ingress PF and egress PF of an XaaS module may be integrated into a PF involved in the procedure 2600.

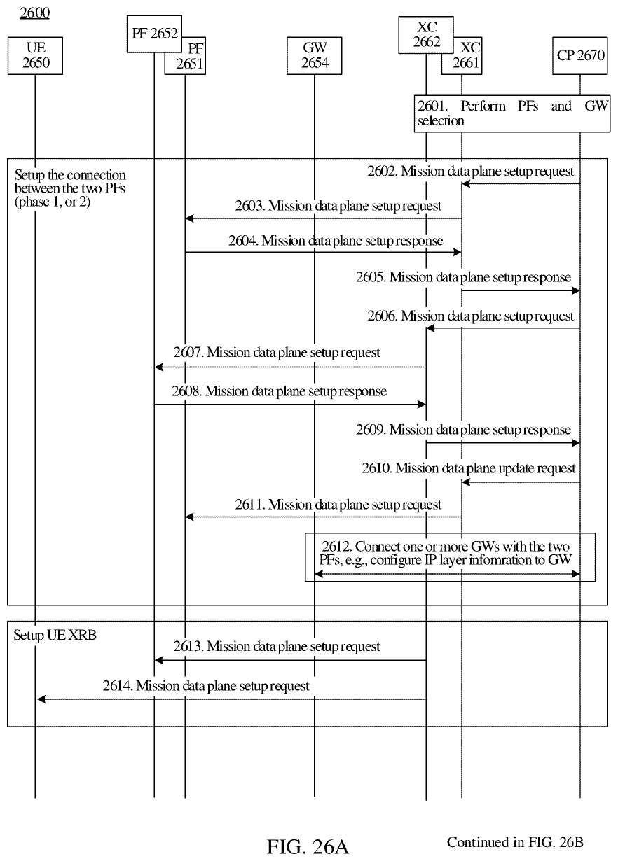

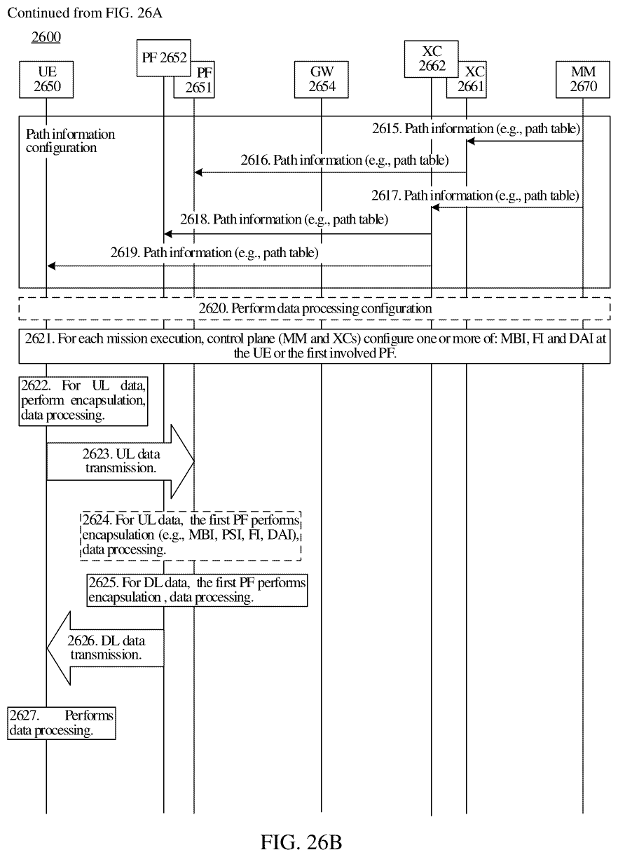

FIGS. 26A and 26B illustrate a procedure for SR-based configuration and mission execution, according to an aspect. According to procedure 2600, the MM 2670 and XCs 2661 and 2662 may coordinate to select the PFs 2651 and 2652 to be involved in a mission. In some aspects, the selection can be performed when the mission is instantiated or when the mission data plane is established.

In an aspect, operations described in reference to 2602 to 2612 may be performed to configure connections between the first PF 2651 and the second PF 2652 of two different XaaS modules. In some aspects, the configuration can be performed when the mission is instantiated or when the mission data plane is established.

In some aspect, procedure 2600 may further include the MM 2670 sending a mission data plane setup request message 2602 to a first XC 2661. In some aspect, the message 2602 may include one or more of: a mission ID, a task ID, a submission ID, a Connection ID, and a PF node ID1. The message 2602 may indicate that the first XC 2661 should control a PF (e.g., PF 2651) identified by the PF node ID1 to setup a Connection identified by the Connection ID. The message 2602 may further indicate that the first XC 2661 should control the network to setup the resource for executing a mission identified by the mission ID, a task identified by the task ID, or a submission identified by the submission ID.

In some aspect, procedure 2600 may further include, after receiving the message 2602, the first XC 2661 sending a mission data plane setup request message 2603 to a first PF 2651. The message 2603 may include one or more of: the mission ID, the task ID, the submission ID, the Connection ID and the PF node ID1. The message 2603 may indicate that the first PF 2651 identified by the PF node ID1 should setup a Connection identified by the Connection ID. The message 2603 may further indicate that the first PF 2651 should setup the resource for executing a mission identified by the mission ID, a task identified by the task ID, or a submission identified by the submission ID.

In some aspect, procedure 2600 may further include, the first PF 2651 setting up a PF entity (e.g., a PF entity of the PF protocol layer) and allocating TNL information (e.g., GTP-U tunnel endpoint identifier (TEID), IP address, or QUIC ID) to setup the TNL tunnel (e.g., GTP-U tunnel, QUIC connection). In some aspects, the TNL tunnel can be identified by the TNL information. In some aspects, the Connection between the PF entity and another PF entity (another PF entity may be on a second PF 2652 side) may be on the top of TNL tunnel.

In some aspect, procedure 2600 may further include, the first PF 2651 sending a mission data plane setup response message 2604 to the first XC 2661. The message 2604 may include one or more of: the mission ID, the task ID, the submission ID, the Connection ID, the first PF side's TNL information, and the mapping between the Connection and TNL tunnel. In some aspects, the mapping between the Connection and TNL tunnel may indicate to a peer node (i.e., the second PF 2652) that data belonging to the Connection should be delivered to the first PF 2651 via which TNL tunnel (the TNL tunnel). In some aspects, one Connection can be mapped to one or multiple TNL tunnels. In some aspects, one or multiple Connections can be mapped to one TNL tunnel. The mapping between the Connection and TNL tunnel can be indicated by the mapping between the Connection ID and the TNL information. In some aspects, the message 2604 may further indicate that the first PF 2651 has successfully setup the resource for executing a mission identified by the mission ID, a task identified by the task ID, or a submission identified by the submission ID.

In some aspects, procedure 2600 may further include, the first XC 2661 sending a mission data plane setup response message 2605 to MM 2670. The message 2605 may include one or more of: the mission ID, the task ID, the submission ID, the Connection ID, the first PF side's TNL information, and the mapping between the Connection and TNL tunnel.

In some aspects, procedure 2600 may further include, MM 2670 sending a mission data plane setup request message 2606 to a second XC 2662. The message 2606 may include one or more of: the mission ID, the task ID, the submission ID, the Connection ID, a PF node ID2, the first PF side's TNL information, the mapping between the Connection and TNL tunnel. The message 2606 may indicate that the second XC 2662 should control a PF identified by the PF node ID2 to setup a Connection identified by the Connection ID. The message 2606 may further indicate that the second XC 2662 should control the network to setup the resource for executing a mission identified by the mission ID, a task identified by the task ID, or a submission identified by the submission ID.

In some aspects, procedure 2600 may further include, after receiving the message 2606, the second XC 2662 sending a mission data plane setup request message 2607 to the second PF 2652. The message 2607 may include one or more of: the mission ID, the task ID, the submission ID, the Connection ID, the PF node ID2, the first PF side's TNL information, and the mapping between the Connection and TNL tunnel. The message 2607 may indicate that the second PF 2652 identified by the PF node ID2 should setup a Connection identified by the Connection ID. The TNL information may notify the second PF 2652 of the TNL information on the first PF side, based on which, the second PF 2652 can deliver data on the tunnel in the follow-up. The mapping between the Connection and TNL tunnel may notify the second PF 2652 that the data belonging to the Connection should be delivered to PF1 via which TNL tunnel (the TNL tunnel). The message 2607 may further indicate that the second PF 2652 should setup the resource for executing a mission identified by the mission ID, a task identified by the task ID, or a submission identified by the submission ID.

In some aspect, procedure 2600 may further include the second PF 2652 setting up a PF entity (e.g., a PF entity of the PF protocol layer) and allocating TNL information (e.g., GTP-U tunnel endpoint identifier (TEID), IP address, QUIC ID) to setup the TNL tunnel (e.g., GTP-U tunnel, QUIC connection). The TNL tunnel can be identified by the TNL information. The Connection between the PF entity and the PF entity on the first PF side may be on the top of TNL tunnel.

In some aspect, procedure 2600 may further include the second PF 2652 sending a mission data plane setup response message 2608 to the second XC 2662. The message 2608 may include one or more of: the mission ID, the task ID, the submission ID, the Connection ID, the second PF side's TNL information, and the mapping between the Connection and TNL tunnel. The mapping between the Connection and TNL tunnel can be indicated by the mapping between the Connection ID and the TNL information. In some aspects, the message 2608 may further indicate that the second PF 2652 has successfully setup the resource for executing a mission identified by the mission ID, a task identified by the task ID, or a submission identified by the submission ID.

In some aspect, procedure 2600 may further include the second XC 2662 sending a mission data plane setup response message 2609 to MM 2670. The message 2609 may include one or more of: the mission ID, the task ID, the submission ID, the second PF side's TNL information, and the mapping between the Connection and TNL layer tunnel. The mapping between the Connection and TNL layer tunnel may indicate a peer node (i.e., the first FP) that the data belonging to the Connection should be delivered to second PF 2652 via which TNL tunnel (the TNL tunnel). In some aspect, one Connection can be mapped to one or multiple TNL layer tunnels. In some aspects, one or multiple Connections can be mapped to one TNL layer tunnel.

In some aspect, procedure 2600 may further include MM 2670 sending a mission data plane update request message 2610 to the first XC 2661. The message 2610 may include one or more of: the mission ID, the task ID, the submission ID, the Connection ID, the second PF side's TNL information, and the mapping between the Connection and TNL tunnel.

In some aspect, procedure 2600 may further include the first XC 2661 sending a mission data plane setup response message 2611 to the first PF 2651. The message 2611 may include one or more of: the mission ID, the task ID, the submission ID, the Connection ID, the second PF side's TNL information, and the mapping between the Connection and TNL tunnel.

In some aspect, operations described in reference to 2602 to 2611 may be based on the assumption that no GW exists to connect two PFs (e.g., first PF 2651 and the second PF 2652 are directly connected) of two XaaS module. In some aspect, one or more GWs may exist to connect the two PFs. If one or more GWs 2654 exists, procedure 2600 may include MM 2670 controlling the one or more GWs 2654 to connect 2612 to the first PF 2651 and the second PF 2652. Connecting the one or more GWs to connect with the two PFs may include configuring IP layer information to the one or more GWs. For example, the MM 2670 may control the one or more GWs 2654 to setup TNL tunnels with the first PF 2651 and the second PF 2652, respectively. In some aspect, MM 2670 may further control the one or more GWs 2654 to bind the TNL tunnels to the Connection between the two first PF 2651 and the second PF 2652. In some aspects, MM 2670 may notify the one or more GWs of the first PF side's TNL information and the second PF side's TNL information. MM 2670 may further notify the first PF 2651 and the second PF 2652 of the one or more GWs sides' TNL information.

In the illustrated example of FIG. 26A, MM 2670 interacts with two XCs (first XC 2661 and second XC 2662) to setup the Connection between two PFs controlled by the two XCs in two different XaaS modules, respectively. In some aspects, MM 2670 may interact with more than two XCs in more than two different XaaS modules to setup the Connections between more than two PFs along a mission data plane. In some aspects, procedure 2600 may be extended to the scenario where more than two PFs may be involved, i.e., MM 2670 may need to interact with each of the multiple XCs, and each of the XCs may interact with its controlled PFs to enable the PFs to setup the Connection among them.

In some aspects, the one or both of the two PFs (first PF 2651 and second PF 2652) can be located in the same network domain or different network domains. For example, both of the two PFs may be located in CN, i.e., the two PFs are CN-PF. In some aspects, both of the two PFs may be located in RAN, i.e., the two PFs are RAN-PF. In some aspects one of the PFs may be located in RAN while the other one may be located in CN. In some aspects, the one or more GWs between the two PFs may be optional. In some aspects, the XC controlling the PF can be located in the same domain as the PF. In some aspects, the MM's deployment can be centralized or distributed, for example, the MM may comprise two different domain MMs which may be respectively located in the same domain with PFs and XCs.

In some aspects, one or more operations described in reference to 2613 to 2614 may be performed to configure a radio link between UE 2650 and RAN for the mission data plane. The configuration can be performed when the mission data plane is established.

In some aspects, when a UE requests to access a network to participate in the mission, an XC may configure the radio link (e.g., XaaS radio bearer (XRB)) between UE and a RAN-PF (i.e., a PF on RAN side). An XRB ID identifies a radio link between the UE and the RAN-PF.

In some aspects, procedure 2600 may further include an XC (e.g., the second XC 2662) sending a mission data plane setup request message 2613 to a RAN-PF (e.g., second PF 2652). The message 2613 may include one or more of: an XRB ID, and configuration parameter on the PF protocol layer of RAN-PF. In some aspects, if the SDAP, PDCP, RLC, MAC sublayers, and PHY layer of the XaaS radio bearer are also deployed on RAN-PF, the message 2613 may also include the configuration parameters on SDAP, PDCP, RLC, MAC sublayers, and PHY layer. In some aspects, if one or more of: the sublayers (SDAP, PDCP, RLC, MAC) and layer (PHY) are deployed on other RAN node (e.g., a RAN base station) instead of the RAN-PF, the XC may interact with the RAN node and configure the corresponding parameters on these one or more of: sublayers and layer, to the RAN node.

In some aspects, procedure 2600 may further include the XC (e.g., the second XC 2662) sending a mission data plane setup request message 2614 to UE 2650. The message 2614 may include one or more of: the XRB ID, and the configuration parameters on the PF protocol layer, SDAP, PDCP, RLC, MAC sublayers and PHY layer of UE. In some aspects, the XC (e.g., the second XC 2662) and RAN-PF (e.g., second PF 2652) may send back and forth messages between the two after message 2613. The back and forth messages are to align between PF 2652 and XC 2662 for the successful configuration of XRB identified by the XRB ID and the related configuration parameter. Similarly, in some aspects, the XC 2662 and the UE 2650 may send back and forth messages between the two after message 2614. The back and forth messages are to align between UE 2650 and XC 2662 for the successful configuration of XRB identified by the XRB ID and the related configuration parameter.

In some aspects, one or more operations described in reference to 2615 to 2619, in FIG. 26B, may be performed to configure path information (e.g., Path table) to the PFs (first PF 2651 and second PF 2652) and UE 2650. The configuration can be performed when the mission is instantiated or when the mission data plane is established, e.g., separately or together with the Connection configuration.

In some aspect, procedure 2600 may further include MM 2670 sending path information to the two XCs (first XC 2661 and second XC 2662 respectively), and each XC may send the path information to one or more of: its controlled PF and the UE. For example, procedure 2600 may include MM 2670 sending a path information message (e.g., path table) 2615 to the first XC 2661. Procedure 2600 may further include the first XC 2661 sending a path information message (e.g., path table) 2616 to its controlled PF (e.g., the first PF 2651). Procedure 2600 may further include MM 2670 sending a path information message (e.g., path table) 2617 to the second XC 2662. Procedure 2600 may further include the second XC 2662 sending a path information message (e.g., path table) 2618 to its controlled PF (e.g., the second PF 2652) and a path information message (e.g., path table) 2619 to UE 2650.

In some aspects, the path information 2615 to 2619 may include one or more of: a Path ID, next hop information and metrics. The path ID may identify a path including one or more of: Connections and an XRB. The next hop information may indicate the Connection or XRB via which to forward the data to the node of the next hop. For example, the data may be forwarded via the XRB in radio link to the node of the next hop (e.g., from UE to RAN-PF, or from RAN-PF to UE). In some aspects, data may be forwarded via the Connection in wired link to the node of the next hop (e.g., from RAN-PF to CN-PF, from CN-PF to RAN-PF, or from one CN-PF to another CN-PF). The metrics may indicate one or both of: data forwarding guarantees and data processing guarantees if the data is delivered via the path to the next hop.

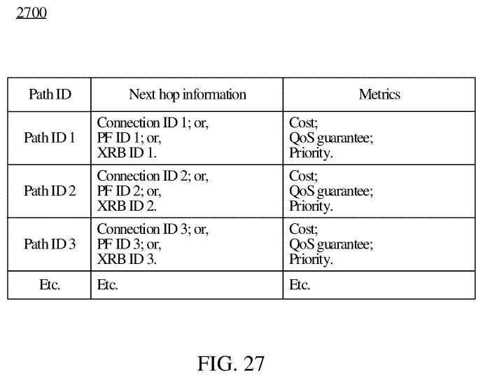

According to an aspect, the path information configured at each PF may be a path table illustrated in FIG. 27. FIG. 27 illustrates a path information (path table), according to an aspect. In an aspect, the path table 2700 may include one or more of: a path ID identifying a path, next hop information and metrics about the path. Accordingly, for each path identified by the path ID, the path table may include next hop information and metric information.

In some aspect, the mapping between the path ID and the next hop information, and (optional) metrics may also be indicated by the path table 2700. The path ID may identify a path including one or more Connections. The next hop information may indicate the Connection via which to forward the data to the node of the next hop. For example, data may be forwarded via an XRB in radio link to the node of the next hop (e.g., from UE to RAN-PF, or from RAN-PF to UE). In some aspects, data may be forwarded via the Connection in wired link to the node of the next hop (e.g., from RAN-PF to CN-PF, from CN-PF to RAN-PF, or from one CN-PF to another CN-PF). In some aspects, the metrics may indicate one or both of: data forwarding guarantees and data processing guarantees if the data is delivered via the corresponding path to the next hop.

In some aspects, the Next hop information can be indicated by a Connection ID (identifying a Connection (e.g., overlay of TNL) between a current PF and the PF of next hop). In some aspects, the Next hop information can be a PF ID (identifying the PF of next hop, e.g., a PF address). In some aspects, the Next hop information can be an XRB ID (identifying a radio link between UE and RAN).

In some aspects, Metrics may indicate a cost (e.g., bandwidth, computing resource). In some aspects, cost may indicate the communication and computing cost if data is delivered via this path (identified by the corresponding path ID in the path table) to the next hop, e.g., communication bandwidth, computing resource cost. In some aspects, metrics may indicate a QoS guarantee. A QoS guarantee may indicate the QoS (e.g., one or both of data forwarding QoS and data processing QoS) that can be guaranteed if the data is delivered via this path (identified by the corresponding path ID in the path table) to the next hop, e.g., delay, rate, accuracy.

In some aspects, metrics may further indicate a priority. Priority may indicate the priority of this path (identified by the corresponding path ID in the path table) to forward data compared with other paths.

In some aspects, the path selection decision may be left to the current PF itself and the path table may hold multiple next-hop entries (e.g., multiple candidate path ID) for next hop PFs. In such cases, the current PF may select the next hop based on the cost metric.

In some aspects, the path information may further include one or more factors, e.g., data source information, and data processing function which can be provided along a path if a path is selected.

In some aspects, a common connection may be established between two PFs (first PF 2651 and second PF 2652) for different paths. In some aspects, different paths connecting a PF and some other PFs may be configured as multiple candidate paths for a task or submission. In some aspects, dedicated connections may be established between two PFs for different paths.

In some aspects, if the traffic path information is configured, the traffic may be forwarded and carried based on the following scheme. The control plane (e.g., one or both of: MM and XC) may configure traffic path information, e.g., configure a path table, to one or both of: PF and UE. The mapping between the paths (e.g., identified by a path ID) and the Connections (e.g., overlaid Connections on top of QUIC connection, GTP-U tunnel, XRB) can be indicated by the configured traffic path information. In some aspects, when the mission is executed, the one or both of: PF and UE, may encapsulate the path selection information into the packet header (e.g., the packet header of PF protocol layer) under the control of control plane (e.g., one or both of MM and XC). In some aspects, data may be forwarded based on the pre-configured path information and the path selection information.

In some aspects, one or more operations described in reference to 2620 may perform the data processing configuration to all the involved PFs or UEs (rather than only the firstly involved PF or UE of a mission) of a mission. The data processing configuration can be performed when the mission is instantiated or when the mission data plane is established.

In some aspects, procedure 2600 may further include the control plane (i.e., MM and XCs) configuring 2620 the data processing treatment parameter to one or more PFs and UE. MM may invoke mission graph or mission instance to see the involved tasks in a mission. MM may further send a task ID or a submission ID to each of the corresponding XC. The XCs may then configure the data processing treatment parameters to one or more of: PF and UE.

For example, an XC may configure a PF entity (e.g., an entity of PF protocol layer on top of TNL (e.g., QUIC, GTP-U), the PF protocol layer can be deployed in PF unit (e.g., RAN-PF unit, CN-PF unit), UE, and RAN) on data processing treatment. The data processing configuration may include a function, according to which, the PF entity may process data as described herein. The configured function can be indicated by a Function ID. In some aspects, the configured function can be a data processing type (e.g., data privacy protection, AI, data sanitization, data normalization, data cleaning, etc.), which may be indicated by one or more of: mission ID and task ID. In some aspect, the configured function can be a data processing algorithm (e.g., FL, GAN, K-anonymity, etc.). In some aspects, the configured function may be information on one or more of: a mission, submission or task to be executed by the PF (e.g., a Mission ID, a submission ID, or a task ID). In some aspects, the Function ID identifying a Function may include or be mapped to a Mission ID identifying a mission. A submission ID may identify a submission, and a task ID may identify a task.

In some aspects, the data processing configuration may further include metrics as described herein. In some aspects, metrics may include XaaS QoS requirement (e.g., computing accuracy level, privacy level) on data processing treatment. In some aspects, metrics may include one or more parameters for security protection, integrity protection, authentication, etc. In some aspects, metrics may include one or more of input data format and output data format.

In some aspects, operations described in reference to 2621 may configure one or more of: the MBIs, FI and DAI at one or more: the first PF 2651, the second PF 2652 and UE 2650. The configuration can be performed when the mission data plane is established or in Mission execution phase.

In some aspects, procedure 2600 may further include the control plane (i.e., MM and XCs) generating and programming 2621 one or more of: MBI, FI and DAI. The generating and programming operations may be performed according to one or more aspects described herein in reference to branching and straight paths, including in reference to FIG. 14, FIG. 15A-D.

In an aspect, the control plane (i.e., MM and XCs) may configure 2621 one or more of: MBI, FI and DAI, to one or both of: the firstly involved PF and UE of a mission (e.g., the firstly involved PF for downlink, and the UE or the firstly involved PF in the uplink).

In an aspect, MM 2670 may cooperate with XCs 2661 and 2662 to generate one or more of: MBIs, FI (if one or more path forks exists in the mission) and DAI (if one or more aggregation point exist in the mission). In some aspects, each of the MBIs may include one or more of: PSI, Function and Metrics. For example, if operations described in reference to 2620 are already performed, which may be optional, each MBI may include a PSI. In some aspects, if operations described in reference to 2620 are not performed, then each MBI may include one or more of: PSI, function and metrics.

As described herein, MM may generate and program one or more of: MBI, FI and DAI, based according to one or more aspects described herein in reference to branching (path with one or more: fork and aggregation) and straight paths (path without fork), including in reference to FIG. 14, FIG. 15A-D.

MM 2670 may then send the generated one or more of: MBI, FI, DAI, a task ID, a submission ID to each of the corresponding XC. The corresponding XC may then configure the one or more of: MBI, FI, DAI, the task ID, and submission ID, to one or both of: the firstly involved PF and UE. The information (one or more of: MBI, FI, DAI, a task ID, a submission ID) may indicate that the firstly involved PF or UE should encapsulate the one or more of: MBI, FI and DAI, into a packet header (i.e., the packet header of the PF protocol layer) for the data of the task identified by the task ID or the submission identified by the submission ID.

In some aspects, procedure 2600 may include one or more operations described in reference to 2622 to 2624 which relate to mission execution in the uplink.

According to an aspect, for uplink data, when executing a mission, a submission or a task, a PF entity deployed at UE (e.g., a PF entity of PF protocol layer in UE) may process 2622 data based on the data processing configuration (e.g., configuration information described in reference to 2620, or configuration information in MBI as described in reference to 2621). In some aspects, the PF entity deployed at UE may further perform 2622 packet header decapsulation as described herein, including in reference to paths with or without fork, e.g., FIGS. 16 to 25. For example, the PF entity deployed at UE may remove the useless information (one or more of: MBI, FI and DAI) from the packet header. Useless information may include, for example, one or more of: the configured MBI for the current PF, and MBIs of the non-forwarding data path(s) (e.g., paths different from the path according to which data is to be forwarded). The PF entity deployed at UE may further encapsulate 2622 into the packet header, the other configured one or more of: MBI, FI and DAI. The PF entity deployed at UE may further include 2622 the processed data result in the packet payload. The PF entity may further forward 2623 the packet via an XRB (established according to operations described in reference to 2613 and 2614) to the first involved PF on network side (e.g., a RAN-PF or CN-PF) based on the PSI configured in MBI (configured based on operations described in reference to 2621) and (optionally) the path information (configured based on operations described in reference to 2615 to 2619).

In some aspects, if the one or more of: MBI, FI and DAI, are not encapsulated into the packet header by the UE based on operations described in reference to 2622, procedure 2600 may further include, the firstly involved PF (e.g., RAN-PF, CN-PF) on network side processing 2624 the received data from the XRB based on the data processing configuration (e.g., configured based on operations described in reference to 2620, or configured in MBI based on operations described in reference to 2621). The firstly involved PF (e.g., RAN-PF, CN-PF) on network side may further perform 2624 packet header decapsulation as described herein, including in reference to paths with or without fork, e.g., FIGS. 16 to 25. For example, the firstly involved PF may remove the useless information (e.g., one or more of: MBI, FI and DAI) from the packet header. Useless information may include, for example, one or more of: the configured MBI for the current PF, and MBIs of the non-forwarding data path(s) (e.g., paths different from the path according to which data is to be forwarded). The firstly involved PF may further encapsulate 2624 into the packet header the other configured one or more of: MBI, FI and DAI. The firstly involved PF may further include the processed data result in the packet payload. The firstly involved PF may further forward the packet via a Connection and lower layer TNL tunnel to the secondly involved PF based on the PSI configured in MBI (e.g., configured based on operations described in reference to 2621) and (optionally) the path information (e.g., configured based on operations described in reference to 2615 to 2619). The Connection and the lower layer TNL tunnel may be established based on operations described in reference to 2602 to 2612. The mapping between the Connection and the lower layer TNL tunnel may also be configured to the firstly and secondly involved PFs based on operations described in reference to 2602 to 2612.

In some aspects, if the one or more of: MBI, FI and DAI, are already encapsulated into the packet header by the UE based on operations described in reference to 2622, the firstly involved PF (e.g., RAN-PF, CN-PF) on network side may process the received data from the XRB based on the data processing configuration (based on the MBI encapsulated in the packet header received according to operations described in reference to 2622 and 2623, or based on the configuration performed in reference to 2620). The firstly involved PF on network side may further performs packet header decapsulation as described herein, including in reference to paths with or without fork, e.g., aspects described in reference to FIGS. 16 to 25. In some aspects, the ingress and egress PF can be deployed independently or integrated into a PF, and as the case may be (e.g., the integrated PF, the ingress PF and the egress PF) may perform packet header decapsulation based on one or more aspects described herein, including in reference to a path with fork (e.g., first method 1600 (FIG. 16), the second method 1700 (FIG. 17) and further in reference to FIGS. 18 to 22) or a path without fork (as described herein including in reference to FIGS. 23 to 25).

For example, the firstly involved PF on network side may remove the useless information (e.g., one or more of: MBI, FI, and DAI. Useless information may include, for example, one or more of: the configured MBI for the current PF, and MBIs of the non-forwarding data path(s) (e.g., paths different from the path according to which data is to be forwarded). The firstly involved PF on the network side may further encapsulate into the packet header the other configured one or more of: MBI, FI and DAI. The firstly involved PF on the network side may further include the processed data result in the packet payload. The firstly involved PF entity on network side may forward the packet via a Connection and lower layer TNL tunnel to the secondly involved PF based on the PSI of the MBI (encapsulated in the packet header received according to operations described in reference to 2622 and 2623) and (optionally) the path information (configured based on operations described in reference to 2615 to 2619). The Connection and the lower layer TNL tunnel may be established based on operations described in reference to 2602 to 2612. The mapping between the Connection and the lower layer TNL tunnel may also be configured to the firstly and secondly involved PFs based on operations described in reference to 2602 to 2612.

In some aspects, procedure 2600 may further include, the secondly involved PF (e.g., RAN-PF, CN-PF) processing the received data from the Connection based on the data processing configuration (based on the MBI encapsulated in the packet header received according to operations described in reference to 2622 and 2623, or based on the configuration performed in reference to 2620). The second involved PF may perform packet header decapsulation as described herein, including in reference to path with or without for, e.g., aspects described in reference to FIGS. 16 to 25. In some aspects, the ingress and egress PF can be deployed independently or integrated into a PF, and as the case may be (e.g., the integrated PF, the ingress PF and the egress PF) may perform packet header decapsulation based on one or more aspects described herein, including in reference to a path with fork (e.g., first method 11600 (FIG. 16), the second method 1700 (FIG. 17, and further in reference to FIGS. 18 to 22) or a path without fork (as described herein including in reference to FIGS. 23 to 25).

For example, the secondly involved PF may remove the useless information (e.g., one or more of: MBI, FI and DAI. Useless information may include, for example, one or more of: the configured MBI for the current PF, and MBIs of the non-forwarding data path(s) (e.g., paths different from the path according to which data is to be forwarded). The secondly involved PF may further encapsulate into the packet header the other configured one or more of: MBI, FI and DAI. The secondly involved PF may further include the processed data result in the packet payload. The secondly involved PF may then forward the data via a Connection and lower layer TNL tunnel to a thirdly involved PF based on the PSI of the MBI (encapsulated in the packet header received according to operations described in reference to 2622 and 2623) and the path information (configured based on operations described in reference to 2615 to 2619). The Connection and the lower layer TNL tunnel may be established based on operations described in reference to 2602 to 2612. The mapping between the Connection and the lower layer TNL tunnel may also be configured to the secondly and thirdly involved PFs based on operations described in reference to 2602 to 2612.

The data may be processed and forwarded until the last involved PF receives the data. The last involved PF may further process the data accordingly. The execution of the mission, submission or task in the uplink may then come to completion.

The one or more operations performed for packet encapsulation and decapsulations for path with or without fork are described in one or more aspects herein including in reference to FIGS. 16 to 25.

In some aspects, procedure 2600 may further include one or more operations described in reference to 2625 to 2627 which relate to mission execution in the downlink.

According to an aspect, for downlink data, when executing a mission, a submission or a task, the firstly involved PF on network side (e.g., CN-PF) may process 2625 data based on the data processing configuration (e.g., configuration information described in reference to 2620, or configuration information in MBI as described in reference to 2621). The firstly involved PF on network side may perform 2625 packet header encapsulation and decapsulation as described in reference to FIGS. 16 to 25. As described, in some aspects, the ingress and egress PF can be deployed independently or integrated into a PF, and as the case may be (e.g., the integrated PF, the ingress PF and the egress PF) may perform packet header decapsulation based on one or more methods described for paths with fork (e.g., (e.g., first method 1600 (FIG. 16), the second method 1700 (FIG. 17) and further in reference to FIGS. 18 to 22) or a path without fork (as described herein including in reference to FIGS. 23 to 25). The firstly involved PF may remove the useless information (e.g., one or more of: MBI, FI and DAI. Useless information may include, for example, one or more of: the configured MBI for the current PF, and MBIs of the non-forwarding data path(s) (e.g., paths different from the path according to which data is to be forwarded). The firstly involved PF may further encapsulate into the packet header the other configured one or more of: MBI, FI and DAI. The firstly involved PF may further include the processed data result in the payload. The firstly involved PF may forward 2626 the data via a Connection and lower layer TNL tunnel to the secondly involved PF (e.g., RAN-PF) based on the PSI configured in MBI (e.g., configured based on operations described in reference to 2621) and the path information (e.g., configured based on operations described in reference to 2615 to 2619). The Connection and the lower layer TNL tunnel may be established based on operations described in reference to 2602 to 2612. The mapping between the Connection and the lower layer TNL tunnel may also be configured to the firstly and secondly involved PFs based on operations described in reference to 2602 to 2612.

In some aspects, procedure 2600 may further include, the secondly involved PF (e.g., RAN-PF) processing the received data from the Connection based on the data processing configuration (based on the MBI encapsulated in the packet header received according to operations described in reference to 2622 and 2623, or based on the configuration performed in reference to 2620). The second involved PF may perform packet header decapsulation as described herein, including in reference to path with or without for, e.g., aspects described in reference to FIGS. 16 to 25. As described herein, in some aspects, the ingress and egress PF can be deployed independently or integrated into a PF, and as the case may be (e.g., the integrated PF, the ingress PF and the egress PF) may perform packet header decapsulation based on one or more aspects described herein, including in reference to a path with fork (e.g., first method 11600 (FIG. 16), the second method 1700 (FIG. 17, and further in reference to FIGS. 18 to 22) or a path without fork (as described herein including in reference to FIGS. 23 to 25).

For example, the secondly involved PF may remove the useless information (e.g., one or more of: MBI, FI and DAI. Useless information may include, for example, one or more of: the configured MBI for the current PF, and MBIs of the non-forwarding data path(s) (e.g., paths different from the path according to which data is to be forwarded). The secondly involved PF may further encapsulate into the packet header the other configured one or more of: MBI, FI and DAI. The secondly involved PF may further include the processed data result in the packet payload. The secondly involved PF may further forward 2626 the data via an XRB to a PF entity of UE 2650 (e.g., a PF entity of PF protocol layer in UE) based on the PSI of the MBI (encapsulated in the packet header according to operations described in reference to 2622 and 2623) and the path information (configured based on operations described in reference to 2615 to 2619). The Connection and the XRB may be established based on operations described in reference to 2602 to 2612. The mapping between the Connection and the XRB may also be configured to the secondly involved PF and the UE based on operations described in reference to 2602 to 2612.

After receiving the data, procedure 2600 may further include, the UE-PF processing 2627 the data. The execution of the mission, submission or task in the downlink may then come to completion.

As described herein, information indicating one or more of: MBI, FI and DAI may be encapsulated into the packet header. MBI may include information indicating one or more of: PSI, function, and metrics. In some aspects, information indicating PSI may indicate a path ID, a Connection ID, an XRB ID, or a PF ID. In some aspects, information indicating function may be a function ID. The function ID may include or be mapped to one or more of: mission ID and task ID. Information indicating function may indicate a process type (data normalization, sanitizations, AI, etc.). Information indicating function ma further indicate a data processing algorithm.

In some aspects, information indicating metrics may indicate an XaaS QoS (e.g., accuracy level, privacy level, etc.) In some aspects, information indicating metrics may further indicate parameters for security protection, integrity protection, authentication, etc. In some aspects, information indicating metrics may include format data, e.g., input data format, output format data.

In some aspect, FI (fork indication information) may be embedded after the forked module as described herein. In some aspect, FI may be embedded before the first forked modules as described herein. In some aspects, DAI (Data aggregation information) may indicate that data from multiple paths should be aggregated.

As described herein, the control plane (e.g., MM and XC) may program one or more of: MBI (including PSI), FI and DAI, according to, for example method 1400 (FIG. 14). In some aspects, the control plane (e.g., MM and XC) may configure the programmed information to the first involved PFs.

In some aspects, on data plane, the firstly involved PF or UE of a mission may perform Packet header encapsulation. All other PFs and UE may perform packet header decapsulation. During packet header decapsulation, a PF may decide the current PF's one or more of: MBI, FI and DAI. During packet header decapsulation, the PF may further decide its following PFs' one or more of: MBI, FI and DAI. During packet header decapsulation, the PF may further remove useless information (one or more of MBI, FI, and DAI) as described herein. One or more PFs (e.g., ingress PF and egress PF) may perform packet header decapsulation according to one or more aspects described herein, for example, in reference to FIGS. 16 to 25.

According to the first method 1600 for packet header decapsulation, a current PF may replicate and transmit multiple unicast packets (with different packet headers and same packet payload) to next-hop PF. According to the second method 1600 for packet header decapsulation, a current PF may transmit multicast packet to next-hop PF.

According to an aspect, information to be encapsulated into the packet header of the PF protocol layer is described when source routing is applied. For example, the information to be encapsulated may apply to a traffic path (of the mission data plane) without or with one or both of fork and aggregation. The information may indicate one or more of: MBI comprising PSI, Function and Metrics. In some aspects, FI may be indicated for traffic paths with forks, and DAI may be indicated for paths with aggregation. As may be appreciated, the information to be encapsulated may apply to a packet header of a PF protocol layer on top of TNL, and also to an IP protocol layer.

Some aspects may provide for enabling the data plane to be reusable and sharable. Accordingly, traffic may be enabled to go through the right or appropriate workflow (traffic path), for example, when traffic path of a mission has one or more of: forks and aggregation.

As described herein, the control plane (e.g., MM and XC) may perform operation to generate one or more of: MBI (comprising PSI), FI and DAI. The control plane (e.g., MM and XC) may generate and program the one or more of: MBI, (comprising PSI), FI and DAI for paths with or without forks, based on one or more aspects described herein.

According to some aspects, the control plane (e.g., MM and XC) may further configure, at one or more PFs, the one or more of: MBI (comprising PSI), FI and DAI. According to some aspects, the control plane (e.g., MM and XC) may further configure path information (e.g., path table) to one or more PFs.

Some aspects may achieve no per-flow/tunnel state inside network. According to some aspects, traffic steering may be enabled. In some aspects, packets may have embedded segment list for traffic steering. According to some aspects, the underlay tunnel may be shared by multiple data flows.

As described herein, one or more operations, at the data plane (i.e., PFs) may be performed. A firstly involved PF or UE of a mission may perform packet header encapsulation. All other PFs and UE may perform packet header decapsulation. Packet header decapsulation may include removing useless information (e.g., one or more of MBI, FI, and DAI) encapsulated in the packet header and forwarding the other one or more of: MBI, FI and DAI, encapsulated in the packet header to the next hop. Removing useless information may include removing the MBI of the current PF, and MBIs of the non-forwarding data path(s) (e.g., paths different from the path according to which data is to be forwarded).

As described herein, the data plane (e.g., a PF) may perform packet header decapsulation for path with fork (and optionally paths with aggregation) according to the first method 1600 and second method 1700. In some aspect, according to the first method 1600 a previous PF may replicate and transmit multiple unicast packets (with different packet headers and same packet payload) to next-hop PF. According to the second method 1700, a previous PF may transmit a multicast packet to next-hop PF.

Some aspects may allow for increased scalability in terms of data processing configuration in the multicast transmission. According to some aspects, the pre-configuration of MDT and replication List may be avoided (stateless), and a more flexible and dynamic data forwarding may be enabled. Further, aspects of the disclosure may be available and efficient for various cases (e.g., unicast, multicast, loop-free, non-loop-free).

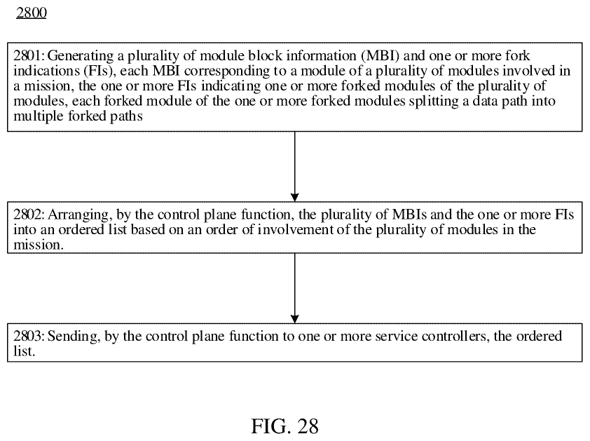

FIG. 28 illustrates a method for programming handling information for data forwarding and data processing, according to an aspect. The method 2800 may be performed by a control plane function, e.g., MM. The method 2800 includes generating 2801 a plurality of module block information (MBIs) and one or more fork indications (FIs), each MBI corresponding to a module of a plurality of modules involved in a mission, the one or more FIs indicating one or more forked modules of the plurality of modules. Each forked module of the one or more forked modules may split a data path into multiple forked paths. The method 2800 may further include arranging 2802 the plurality of MBIs and the one or more FIs into an ordered list based on an order of involvement of the plurality of modules in the mission. The method 2800 may further include sending 2803 to one or more service controllers, the ordered list.

In some aspects, arranging the plurality of MBIs and the one or more FIs into an ordered list based on an order of mission involvement of the plurality of modules may further include setting, at a first position in the ordered list, a first MBI of the plurality of MBIs corresponding to a first module of the plurality of modules, the first module being a firstly involved module based on the order of involvement.

In some aspects, the method may further include setting, in the ordered list and after the first MBI, one or more MBIs corresponding to one or more modules involved in the mission after the first module up to and including a first forked module. The one or more MBIs may be arranged according to the order of involvement of the corresponding one or more modules and the first forked module in the mission. The first forked module may split the data path into a plurality of forked paths of the first forked module.

In some aspects, the first module is a first forked module, and the first MBI is an MBI of the first forked module. The first forked module may split the data path into a plurality of forked paths of the first forked module.

In some aspects, the method may further include setting a plurality of sets of handling data in the ordered list after the MBI of the first forked module. Each set of handling data may correspond to a respective forked path of the plurality of forked paths of the first forked module. Each set of handling data may comprise one or more of MBIs corresponding to one or more modules in the respective forked path. Each set of handling data may further comprise an FI corresponding to a first module in the respective forked path and being involved in the mission after the first forked module.

In some aspects, the plurality of forked paths of the first forked module may execute the mission in parallel.

In some aspects, setting a plurality of sets of handling data in the ordered list after the after the MBI of the first forked module includes, for each forked path of the plurality of forked paths of the first forked module, setting the respective FI and the respective one or more MBIs in the ordered list based on the order of involvement in the mission of the corresponding one or more modules in the respective forked path.

In some aspects, the method 2800 may further include setting in the ordered list after the MBI of the first forked module and before the plurality of sets of handling data, an FI corresponding to the first forked module.

In some aspects, at least one of the plurality of forked paths of the first forked modules comprises one or more forked modules. For each of the at least one of the plurality of forked paths, each forked module of the one or more forked modules may split a respective data path into a respective plurality of forked paths of said each forked module. For each of the at least one of the plurality of forked paths, the one or more forked modules and the first forked module may be involved in the mission according to the order of involvement. For each of the at least one of the plurality of forked paths, the method may further include, for each respective forked module of the one or more forked modules, setting in the ordered list and after an MBI of a forked module previous to said each forked module, as determined according to the order of involvement, a first handling data. The first handling data may comprise one or more MBIs corresponding to one or more modules involved in the mission after the forked module previous to said each forked module, and up to and including said each forked module. The first handling data may further comprise an FI corresponding to a first modules being involved in the mission after the forked module previous to said each forked module.

For each of the at least one of the plurality of forked paths, the method may further include, for each respective forked module of the one or more forked modules, setting, by the control plane function, in the ordered list and after the first handling data, a plurality of sets of handling data. Each set of handling data may correspond to a respective forked path of the respective plurality of forked paths of said each forked module. Each set of handling data may comprise one or more of MBIs corresponding to one or more modules involved in the respective forked path. Each set of handling data may further comprise an FI corresponding to a first module in the respective forked path and being involved in the mission after said each forked module.

In some aspects, for each of at least one of the plurality of sets of handling data, the respective one or more MBIs correspond to one or more modules involved in the respective forked path, and up to and including a forked module of the one or more forked modules subsequent to said each forked module, as determined according to the order of involvement.

In some aspects, the respective plurality of forked paths of each forked module of the plurality of forked module may execute the mission in parallel.

In some aspects, the one or more MBIs and the FI in the first handling data may be arranged according to the order of involvement in the mission of their corresponding one or more modules. In some aspects, the one or more MBIs and the FI in said each set of handling data may be arranged according to the order of involvement in the mission of their corresponding one or more modules.

In some aspects, for each forked module of the one or more forked modules of the at least one of the plurality of forked paths of the first forked module, the method may further include setting, in the ordered list, after the MBI of the forked module previous to said each forked module and before the first handling data, an FI corresponding to the forked module previous to said each forked module.

In some aspects, for each forked module of the one or more forked modules of the at least one of the plurality of forked paths of the first forked module, the method may further include setting, in the ordered list, after the first handling data and before the plurality of sets of handling data, an FI corresponding to said each forked module.

In some aspects, the method 2800 may further include setting an FI value to an FI corresponding to the first forked module. In some aspects, the method 2800 may further include, for each FI corresponding to said each forked module, setting a respective FI value based on an FI value corresponding to the FI of the forked module previous to said each forked module.

In some aspects, each MBI of the plurality of MBIs comprises one or more of: a path selection information (PSI), a function indication, metrics, and a data aggregation indication (DAI). In some aspects, the PSI indicates one or more of: a path identifier (ID) identifying a traffic path from a processing function (PF) corresponding to said each MBI to a next-hop PF of the PF; a connection ID identifying a connection between the PF and the next-hop PF; an ID of the next-hop PF; an ID of a radio bearer; and an ID of the PF.

In some aspects, the function indication is one or more IDs of one or more functions according to which one or more PFs involved in the mission process data, the one or more functions including: a data processing type, a data processing algorithm, the mission, a submission of the mission, and a task of the mission.

In some aspects, the metrics indicate a requirement on data processing for a module corresponding to said each MBI, the metrics including one or more of: a quality of service (QoS) requirement on one or both of data processing and data forwarding, a parameter for security protection, a parameter for integrity protection, a parameter for authentication, an input data format, and an output data format.

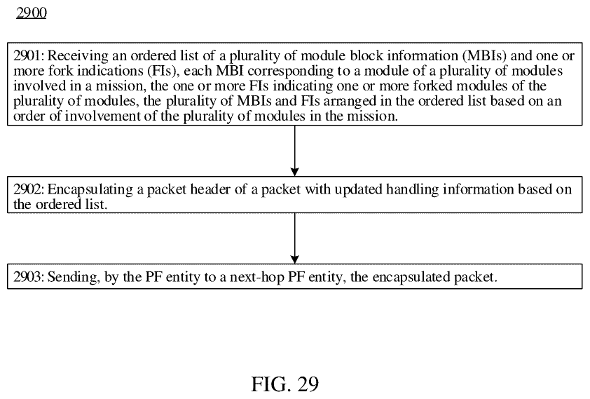

FIG. 29 illustrates another method, according to an aspect. The method 2900 may be performed by a PF entity involved in a mission. The method 2900 includes, receiving 2901, by a PF entity involved in a mission, an ordered list of a plurality of module block information (MBIs) and one or more fork indications (FIs), each MBI corresponding to a module of a plurality of modules involved in a mission, the one or more FIs indicating one or more forked modules of the plurality of modules, the plurality of MBIs and FIs arranged in the ordered list based on an order of involvement of the plurality of modules in the mission. The method 2900 may further include encapsulating 2902, by the PF entity, a packet header of a packet with updated handling data based on the ordered list. The method 2900 may further include sending 2903, by the PF entity, to a next-hop PF entity the encapsulated packet. In some aspects, the encapsulated packet may be sent based on a path selection information (PSI) of an MBI of the PF entity, the MBI of the PF entity being included in the ordered list.

In some aspects, the PF entity receives the ordered list from a service controller. In some aspects, the updated handling data may comprise the ordered list of MBIs and the one or more FIs and excludes the MBI of the PF entity.

In some aspects, the PF entity is at a forked module and the next-hop PF entity is on a first forked path of a plurality of forked paths beginning from the PF entity. In some aspects, the updated handling data includes one or more MBIs of the plurality of MBIs corresponding to one or more modules of the plurality of modules involved in the first forked path. The one or more MBIs may be arranged according to an order of mission involvement of the one or more modules in the first forked path. In some aspects, the encapsulated packet is a unicast packet.

In some aspects the updated handling data may further include one or more FIs of one or more forked modules involved in the first forked path. In some aspects, the one or more MBIs and the one or more FIs may be arranged according to an order of mission involvement of the one or more modules and the one or more forked modules in the first forked path.

In some aspects, the PF entity is at a forked module and sending, by the PF entity to a next-hop PF entity, the encapsulated packet may include sending, by the PF entity to each of a plurality of next-hop PF entities, the encapsulated packet as a multicast packet, each of the plurality of next-hop PF entities being on a respective forked path of a plurality of forked paths beginning from the PF entity.

In some aspects, for each of the plurality of next-hop PF entities that an identifier (ID) of said each next-hop PF entity is indicated in an MBI of the said each next-hop PF entity included in the ordered list, the updated handling data comprises one or more of: MBIs and FIs of a set of modules of the plurality of modules involved in the plurality of forked paths.

In some aspects, for each of the plurality of next-hop PF entities that an identifier (ID) of said each next-hop PF entity is indicated in the MBI of the PF entity, the updated handling data may include one or more of MBIs and FIs: of the PF entity and a set of modules of the plurality of modules involved in the plurality of forked paths.

In some aspects, the method 2900 may further include processing, by the PF entity, data based on a data processing configuration to obtain a processed result, wherein the processed result is included in a payload of the encapsulated packet.

In some aspects, the data processing configuration is indicated via one of: a message received by the PF entity from a control plane function indicating one or more functions according to which the PF entity processes the data, and the MBI of the PF entity.

In some aspects, the PF entity is at a user equipment, and the encapsulated packet is sent via a radio bearer identified by the PSI of the MBI of the PF entity, the MBI of the PF entity being included in the ordered list.

In some aspects, the method 2900 may further include receiving, by the PF entity from another PF entity at a user equipment, the data associated with the mission.

In some aspects, the PF entity receives the ordered list in the packet header of the packet from another PF entity. In some aspects, the method 2900 may further include receiving, by the PF entity from the another PF entity, the data associated with the mission in the packet.

In some aspects, one of the PF entity and the next-hop PF entity is a core network (PF) entity and the other is a radio access network (RAN) PF. In some aspects, the PF entity is a core network (CN) PF entity, and the next-hop PF entity is a radio access network (RAN) PF.

In some aspects, the next-hop PF entity is at a user equipment (UE), and the encapsulated packet is sent via a radio bearer identified by a path selection information (PSI) of the MBI of the PF entity, the MBI of the PF entity being included in the ordered list. In some aspects, the PF entity is a radio access network (RAN) PF entity.

In some aspects, each MBI of the plurality of MBIs may include one or more of: a respective path selection information (PSI), a function indication, metrics, and a data aggregation indication (DAI). In some aspects, the respective PSI may indicate one or more of: a path identifier (ID) identifying a traffic path from a processing function (PF) of said each MBI to a next-hop PF; a connection ID identifying a connection between the PF of said MBI and the next-hop PF; an ID of the next-hop PF; an ID of a radio bearer; and an ID of the PF of said each MBI.

In some aspects, the function indication is one or more IDs of one or more functions according to which one or more PFs involved in the mission process data, the one or more functions including: a data processing type, a data processing algorithm, the mission, a submission of the mission, and a task of the mission.

In some aspects, the metrics indicate a requirement on data processing for a module corresponding to said each MBI, the metrics including one or more of: a quality of service (Qos) requirement on one or both of data processing and data forwarding, a parameter for security protection, a parameter for integrity protection, a parameter for authentication, an input data format, and an output data format.

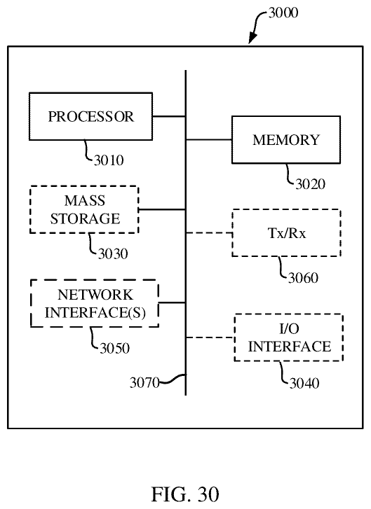

FIG. 30 illustrates an apparatus 3000 that may perform any or all of operations of the above methods and features explicitly or implicitly described herein, according to different aspects of the present disclosure. For example, a computer equipped with network function may be configured as the apparatus 3000. In some aspects, the apparatus 3000 may be a network function, a RAN function, a control plane function, a network node, a gateway, a service controller, a device, a processing function or an entity described herein which may be configured to perform one or more operations described herein. In some aspect, apparatus 3000 can be a device that connects to the network infrastructure over a radio interface, such as a mobile phone, smart phone or other such device that may be classified as user equipment (UE). In some aspects, the apparatus 3000 may be a Machine Type Communications (MTC) device (also referred to as a machine-to-machine (m2m) device), or another such device that may be categorized as a UE despite not providing a direct service to a user. In some aspects, apparatus 3000 may be used to implement one or more aspects described herein. For example, the apparatus 3000 may be configured to perform operations performed by one or more entities and functions described herein.

As shown, the apparatus 3000 may include a processor 3010, such as a Central Processing Unit (CPU) or specialized processors such as a Graphics Processing Unit (GPU) or other such processor unit, memory 3020, non-transitory mass storage 3030, input-output interface 3040, network interface 3050, and a transceiver 3060, all of which are communicatively coupled via bi-directional bus 3070. According to certain aspects, any or all of the depicted elements may be utilized, or only a subset of the elements. Further, apparatus 3000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 3020 may include any type of non-transitory memory such as static random-access memory (SRAM), dynamic random-access memory (DRAM), synchronous DRAM (SDRAM), read-only memory (ROM), any combination of such, or the like. The mass storage element 3030 may include any type of non-transitory storage device, such as a solid-state drive, hard disk drive, a magnetic disk drive, an optical disk drive, USB drive, or any computer program product configured to store data and machine executable program code. According to certain aspects, the memory 3020 or mass storage 3030 may have recorded thereon statements and instructions executable by the processor 3010 for performing any of the aforementioned method operations described above.

Aspects of the present disclosure can be implemented using electronics hardware, software, or a combination thereof. In some aspects, this may be is implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
generating, by a control plane function, a plurality of module block information (MBI) and one or more fork indications (FIs), each MBI corresponding to a module of a plurality of modules involved in a mission, the one or more FIs indicating one or more forked modules of the plurality of modules, each forked module of the one or more forked modules splitting a data path into multiple forked paths;
arranging, by the control plane function, the plurality of MBIs and the one or more FIs into an ordered list based on an order of involvement of the plurality of modules in the mission; and
sending, by the control plane function to one or more service controllers, the ordered list.

2. The method of claim 1, wherein arranging, by the control plane function, the plurality of MBIs and the one or more FIs into the ordered list based on the order of involvement of the plurality of modules comprises:
setting, by the control plane function, at a first position in the ordered list, a first MBI of the plurality of MBIs corresponding to a first module of the plurality of modules, the first module being a first-involved module based on the order of involvement.

3. The method of claim 2 further comprising:
setting, by the control plane function, in the ordered list and after the first MBI, one or more MBIs corresponding to one or more modules involved in the mission after the first module up to and including a first forked module, the one or more MBIs arranged according to the order of involvement of the corresponding one or more modules and the first forked module in the mission, and the first forked module splits the data path into a plurality of forked paths of the first forked module.

4. The method of claim 2, wherein the first module is a first forked module, the first MBI is an MBI of the first forked module, and the first forked module splits the data path into a plurality of forked paths of the first forked module.

5. The method of claim 3, further comprising:
setting, by the control plane function, a plurality of sets of handling data in the ordered list after the MBI of the first forked module, each set of handling data corresponding to a respective forked path of the plurality of forked paths of the first forked module, and comprising:
a respective one or more of MBIs corresponding to one or more modules in the respective forked path; and
a respective FI corresponding to a first module in the respective forked path and being involved in the mission after the first forked module.

6. The method of claim 5, wherein the plurality of forked paths of the first forked module execute the mission in parallel.

7. The method of claim 5, wherein setting, by the control plane function, the plurality of sets of handling data in the ordered list after the MBI of the first forked module comprises:
for each forked path of the plurality of forked paths of the first forked module:
setting, by the control plane function, the respective first FI and the respective one or more MBIs in the ordered list based on the order of involvement in the mission of the corresponding one or more modules in the respective forked path.

8. The method of claim 5 further comprising:
setting, by the control plane function, in the ordered list after the MBI of the first forked module and before the plurality of sets of handling data, an FI corresponding to the first forked module.

9. The method of claim 3, wherein at least one of the plurality of forked paths of the first forked modules comprises one or more forked modules, and for each of the at least one of the plurality of forked paths:
each forked module of the one or more forked modules, splits a respective data path into a respective plurality of forked paths of said each forked module; and
for each forked module of the one or more forked modules, the one or more forked modules and the first forked module being involved in the mission according to the order of involvement, the method further comprises:
setting, by the control plane function, in the ordered list and after an MBI of a forked module previous to said each forked module, as determined according to the order of involvement, first handling data comprising:
one or more MBIs corresponding to one or more modules involved in the mission after the forked module previous to said each forked module, and up to and including said each forked module; and
an FI corresponding to a first modules being involved in the mission after the forked module previous to said each forked module;
setting, by the control plane function, in the ordered list and after the first handling data, a plurality of sets of handling data, each set of handling data corresponding to a respective forked path of the respective plurality of forked paths of said each forked module, and comprising:
one or more of MBIs corresponding to one or more modules involved in the respective forked path; and
an FI corresponding to a first module in the respective forked path and being involved in the mission after said each forked module.

10. The method of claim 9, wherein for each of at least one of the plurality of sets of handling data, the respective one or more MBIs correspond to one or more modules involved in the respective forked path, and up to and including a forked module of the one or more forked modules subsequent to said each forked module, as determined according to the order of involvement.

11. The method of claim 9, wherein the respective plurality of forked paths of each forked module of the one or more forked modules execute the mission in parallel.

12. The method of claim 9, wherein:
the one or more MBIs and the FI in the first handling data are arranged according to the order of involvement in the mission of their corresponding one or more modules; and
the one or more MBIs and the FI in said each set of handling data are arranged according to the order of involvement in the mission of their corresponding one or more modules.

13. The method of claim 9, wherein for each forked module of the one or more forked modules, the method further comprises:
setting, by the control plane function, in the ordered list, after the MBI of the forked module previous to said each forked module and before the first handling data, an FI corresponding to the forked module previous to said each forked module; and
setting, by the control plane function, in the ordered list, after the first handling data and before the plurality of sets of handling data, an FI corresponding to said each forked module.

14. The method of claim 13 further comprising:
setting, by the control plane function, an FI value to an FI corresponding to the first forked module; and
for each FI corresponding to said each forked module, setting, by the control plane function, a respective FI value based on an FI value corresponding to the FI of the forked module previous to said each forked module.

15. The method of claim 1, wherein each MBI of the plurality of MBIs comprises one or more of: a path selection information (PSI), a function indication, metrics, or a data aggregation indication (DAI).

16. The method of claim 15, wherein the PSI indicates one or more of: a path identifier (ID) identifying a traffic path from a processing function (PF) corresponding to said each MBI to a next-hop PF of the PF; a connection ID identifying a connection between the PF and the next-hop PF; an ID of the next-hop PF; an ID of a radio bearer; or an ID of the PF.

17. The method of claim 15, wherein the function indication is one or more IDs of one or more functions according to which one or more PFs involved in the mission process data, the one or more functions including: a data processing type, a data processing algorithm, the mission, a submission of the mission, or a task of the mission.

18. The method of claim 15, wherein the metrics indicate a requirement on data processing for a module corresponding to said each MBI, the metrics including one or more of: a quality of service (QOS) requirement on one or both of data processing and data forwarding, a parameter for security protection, a parameter for integrity protection, a parameter for authentication, an input data format, or an output data format.

19. An apparatus comprising:
at least one processor; and
at least one machine-readable medium storing executable instructions which when executed by the at least one processor configure the apparatus to:
generate a plurality of module block information (MBI) and one or more fork indications (FIs), each MBI corresponding to a module of a plurality of modules involved in a mission, the one or more FIs indicating one or more forked modules of the plurality of modules, each forked module of the one or more forked modules splitting a data path into multiple forked paths;
arrange the plurality of MBIs and the one or more FIs into an ordered list based on an order of involvement of the plurality of modules in the mission; and
send to one or more service controllers, the ordered list.

20. A computer device comprising a non-transitory computer readable medium having instructions stored thereon which, when executed by a computer processor, causes the computer to:
generate a plurality of module block information (MBI) and one or more fork indications (FIs), each MBI corresponding to a module of a plurality of modules involved in a mission, the one or more FIs indicating one or more forked modules of the plurality of modules, each forked module of the one or more forked modules splitting a data path into multiple forked paths;
arrange the plurality of MBIs and the one or more FIs into an ordered list based on an order of involvement of the plurality of modules in the mission; and
send to one or more service controllers, the ordered list.
